(19) United States
(12) Patent Application Publication
(10) Pub. No.: US 2016/0026384 A1
(43) Pub. Date: Jan. 28, 2016

(54) METHOD FOR DISPLAY CONTROL AND ELECTRONIC DEVICE USING THE SAME

(71) Applicant: Samsung Electronics Co., Ltd., Gyeonggi-do (KR)

(72) Inventors: Minkyung HWANG, Seoul (KR); Donghyun YEOM, Gyeonggi-do (KR); Doosuk KANG, Gyeonggi-do (KR)

(21) Appl. No.: 14/799,679

(22) Filed: Jul. 15, 2015

(30) Foreign Application Priority Data
Jul. 23, 2014 (KR) 10-2014-0093217

(51) Int. Cl. G06F 3/0488; G06F 3/0482; G06F 3/0484

(52) U.S. Cl. CPC G06F 3/04886; G06F 3/04842; G06F 3/0482

(57) ABSTRACT

A method and electronic device are disclosed herein. The electronic device includes a display and a processor which executes the method, including displaying at least two display regions on a display of the electronic device, displaying an execution screen of an application on one of the at least two display regions, and in response to detecting an input event for displaying a user interface, displaying the user interface on one of the at least two display regions.

### CLAIM OF PRIORITY

This application claims the benefit under 35 U.S.C. §119(a) of a Korean patent application filed on Jul. 23, 2014 in the Korean Intellectual Property Office and assigned Serial No. 10-2014-0093217, the entire disclosure of which is hereby incorporated by reference.

### TECHNICAL FIELD

The present disclosure relates to a display control in an electronic device and, more particularly, to an electronic device and method for controlling a display of a plurality of applications on a screen of the electronic device.

### BACKGROUND

With the remarkable growth of digital technologies, a great variety of mobile devices has been developed that allow users more diverse communication and personal information processing, even on the move. As such, these devices grow increasingly popular in these days. Particularly, mobile devices today have outgrown their respective traditional fields and have reached a mobile convergence stage in which those other device types have been incorporated.

Nowadays, a mobile device typically has the ability to support various functions such as a voice call, a video call, a short message service (SMS), a multimedia message service (MMS), an email, an electronic organizer, a digital camera, a broadcasting receiver, a music player, a video player, an internet access, a messenger, a social network service (SNS), and the like.

Inherently a mobile device has a small-sized screen for display. Therefore, a mobile device usually offers a single application view at a time, even though some applications can offer an additional views through, for example, a pop-up window. In other words, although two or more applications execute concurrently, a display screen merely offers a single view of selected one application. Even so, a user may typically desire to simultaneously use multiple functions.

### SUMMARY

Accordingly, embodiments disclosed herein provide a display control method and a related electronic device.

According to an embodiment of this disclosure, a method in an electronic device is disclosed, the method including displaying at least two display regions on a display of the electronic device, displaying an execution screen of an application on one of the at least two display regions, and in response to detecting an input event for displaying a user interface, displaying the user interface on one of the at least two display regions.

According to an embodiment of this disclosure, the method may further include detecting a move input event dragging the displayed user interface to a new display region of the at least two display regions, and moving the user interface to the new display region in response to the detected move input event.

According to an embodiment of this disclosure, the method may further include displaying a quick panel providing status information of the electronic device outside of the at least two display regions, and detecting an input event to the quick panel, and in response to detecting the input event to the quick panel, displaying the quick panel on an entirety of one of the at least two display regions.

According to an embodiment of this disclosure, an electronic device is disclosed, including a display unit, and a processor configured to: control the display unit to display at least two display regions, control the display unit to display an execution screen of an application on one of the at least two display regions, and in response to detecting an input event for displaying a user interface, control the display unit to display the user interface on one of the at least two display regions.

According to an embodiment of this disclosure, a non-transitory computer-readable storage medium is disclosed, the medium recording thereon a program executable by a processor for performing operations of: displaying at least two display regions on a display of the electronic device, displaying an execution screen of an application on one of the at least two display regions, and in response to detecting an input event for displaying a user interface, displaying the user interface on one of the at least two display regions.

### BRIEF DESCRIPTION OF THE DRAWINGS

FIG. 1 is a block diagram illustrating a network environment including an electronic device in accordance with various embodiments of the present disclosure;

FIG. 2 is a schematic diagram illustrating a display control of an electronic device in accordance with various embodiments of the present disclosure;

FIG. 3 is a schematic diagram illustrating another display control of an electronic device in accordance with various embodiments of the present disclosure;

FIG. 4 is a schematic diagram illustrating still another display control of an electronic device in accordance with various embodiments of the present disclosure;

FIG. 5, FIG. 6, FIG. 7 and FIG. 8 are screenshots illustrating examples of displaying additional information on a screen in accordance with various embodiments of the present disclosure;

FIG. 9 is a schematic diagram illustrating a move of a user interface on a screen in accordance with various embodiments of the present disclosure;

FIG. 10A, FIG. 10B, FIG. 11A and FIG. 11B are schematic diagrams illustrating examples of displaying a quick panel on a screen in accordance with various embodiments of the present disclosure;

FIG. 12 is a schematic diagram illustrating an example of displaying a notification UI on a screen in accordance with various embodiments of the present disclosure;

FIG. 13 is a flow diagram illustrating a process of displaying a user interface on a screen in accordance with various embodiments of the present disclosure;

FIG. 14 is a flow diagram illustrating a process of moving a user interface on a screen in accordance with various embodiments of the present disclosure;

FIG. 15 is a flow diagram illustrating a process of displaying a quick panel on a screen in accordance with various embodiments of the present disclosure;

FIG. 16 is a flow diagram illustrating a process of displaying a notification UI on a screen in accordance with various embodiments of the present disclosure;

FIG. 17 is a block diagram illustrating an electronic device in accordance with various embodiments of the present disclosure; and

FIG. 18 is a diagram illustrating the exchange of protocols between electronic devices in accordance with various embodiments of the present disclosure.

### DETAILED DESCRIPTION

Hereinafter, the present disclosure will be described with reference to the accompanying drawings. This disclosure may be embodied in many different forms and should not be construed as limited to the embodiments set forth herein. Rather, the disclosed embodiments are provided so that this disclosure will be thorough and complete, and will fully convey the disclosure to those skilled in the art. The principles and features of this disclosure may be employed in varied and numerous embodiments without departing from the disclosure.

The expressions such as “include” and “may include” which may be used in various embodiments of the present disclosure denote the presence of the disclosed functions, operations, and constituent elements and do not limit one or more additional functions, operations, and constituent elements. Additionally, in various embodiments of the present disclosure, the terms such as “comprise”, “include”, and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Furthermore, in various embodiments of the present disclosure, the expression “or” includes any and all combinations of the associated listed words. For example, the expression “A or B” may include A, may include B, or may include both A and B.

In various embodiments of the present disclosure, expressions including ordinal numbers, such as “first” and “second,” etc., and/or the like, may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them the first user device and the second user device are user devices. For example, a first element could be termed a second element, and similarly, a second element could be also termed a first element without departing from the present disclosure.

In the case where according to which a component is referred to as being “connected” or “accessed” to other component, it should be understood that not only the component is directly connected or accessed to the other component, but also there may exist another component between them the component and the other component. Meanwhile, in the case where according to which a component is referred to as being “directly connected” or “directly accessed” to other component, it should be understood that there is no component therebetween.

The terms used in the present disclosure are used to describe specific various embodiments, and are not intended to limit the present disclosure. As used herein, the singular forms are intended to include the plural forms as well, unless the context clearly indicates otherwise.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purposes and not for the purpose of limiting the present disclosure as defined by the appended claims and their equivalents.

An electronic device according to this disclosure may be a device that involves a display function. For example, an electronic device may be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, an electronic accessory, or a smart watch).

According to some embodiments, an electronic device may be a smart home appliance that involves a display function. For example, an electronic device may be a TV, a DVD (Digital Video Disk) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to some embodiments, an electronic device may be a medical device (e.g., MRA (Magnetic Resonance Angiography), MRI (Magnetic Resonance Imaging), CT (Computed Tomography), ultrasonography, etc.), a navigation device, a GPS (Global Positioning System) receiver, an EDR (Event Data Recorder), an FDR (Flight Data Recorder), a car infotainment device, electronic equipment for ship (e.g., a marine navigation system, a gyrocompass, etc.), avionics, security equipment, an industrial or home robot, an ATM (Automatic Teller's Machine), or a POS (Point of Sales).

According to some embodiments, an electronic device may be furniture or part of a building or construction having a display function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. Also, an electronic device disclosed herein may be a flexible device. As well understood by those skilled in the art, an electronic device disclosed herein is used as an example and not to be considered as a limitation of this disclosure.

Now, an electronic device according to various embodiments will be described with reference to the accompanying drawings. The term ‘user’ to be used herein may refer to a person or machine (e.g., an artificial intelligence apparatus or system) using an electronic device.

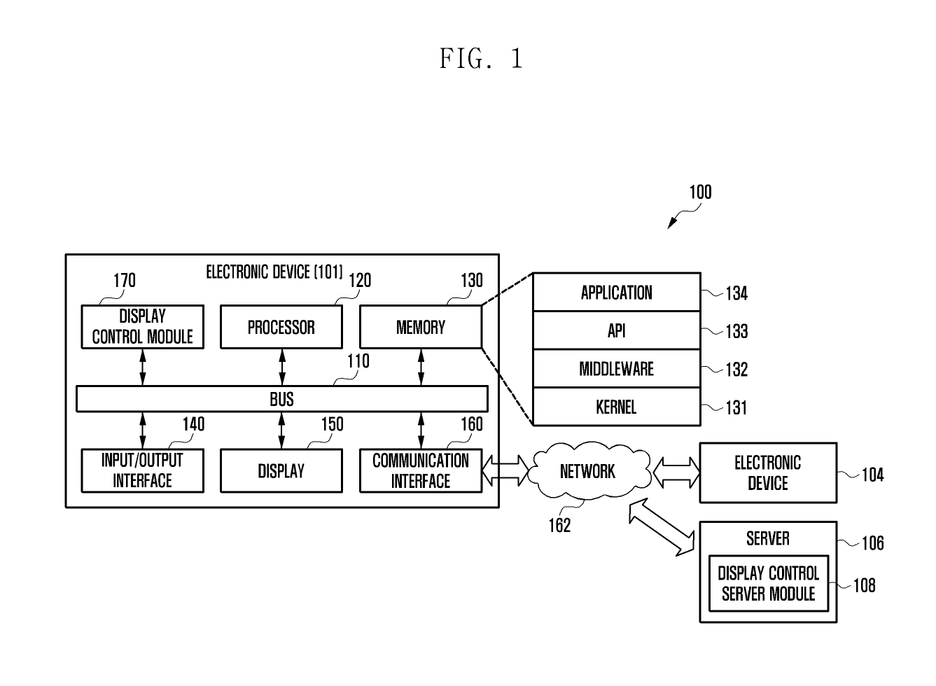

FIG. 1 illustrates a network environment 100 including an electronic device 101 according to various embodiments of the present disclosure. Referring to FIG. 1, the electronic device 101 includes a bus 110, a processor 120, a memory 130, an input/output interface 140, a display 150, a communication interface 160, and a display control module 170.

The bus 110 may be a circuit connecting the above described components and transmitting communication (for example, a control message) between the above described components.

The processor 120 receives commands from other components (for example, the memory 130, the input/output interface 140, the display 150, the communication interface 160, or the display control module 170) through the bus 110, analyzes the received commands, and executes calculation or data processing according to the analyzed commands.

The memory 130 stores commands or data received from the processor 120 or other components (for example, the input/output interface 140, the display 150, the communication interface 160, or the display control module 170) or generated by the processor 120 or other components. The memory 130 may include programming modules, for example, a kernel 131, middleware 132, an Application Programming Interface (API) 133, and an application 134. Each of the aforementioned programming modules may be implemented by software, firmware, hardware, or a combination of two or more thereof.

The kernel 131 controls or manages system resources (for example, the bus 110, the processor 120, or the memory 130) used for executing an operation or function implemented by the remaining other programming modules, for example, the middleware 132, the API 133, or the application 134. Further, the kernel 131 provides an interface for accessing individual components of the electronic device 101 from the middleware 132, the API 133, or the application 134 to control or manage the components.

The middleware 132 performs a relay function of allowing the API 133 or the application 134 to communicate with the kernel 131 to exchange data. Further, in operation requests received from the application 134, the middleware 132 performs a control for the operation requests (for example, scheduling or load balancing) by using a method of assigning a priority, by which system resources (for example, the bus 110, the processor 120, the memory 130 and the like) of the electronic device 101 can be used, to the application 134.

The API 133 is an interface by which the application 134 can control a function provided by the kernel 131 or the middleware 132 and includes, for example, at least one interface or function (for example, command) for a file control, a window control, image processing, or a character control.

According to various embodiments, the application 134 may include a Short Message Service (SMS)/Multimedia Messaging Service (MMS) application, an email application, a calendar application, an alarm application, a health care application (for example, application measuring quantity of exercise or blood sugar) or an environment information application (for example, application providing information on barometric pressure, humidity or temperature). Additionally or alternatively, the application 134 may be an application related to an information exchange between the electronic device 101 and an external electronic device (for example, electronic device 104). The application related to the information exchange may include, for example, a notification relay application for transferring particular information to the external electronic device or a device management application for managing the external electronic device.

For example, the notification relay application may include a function of transmitting notification information generated by another application (for example, an SMS/MMS application, an email application, a health care application or an environment information application) of the electronic device 101 to the external electronic device (for example, electronic device 104). Additionally or alternatively, the notification relay application may receive notification information from, for example, the external electronic device 104 and provide the received notification information to the user. The device management application may manage (for example, install, remove, or update) at least a part of functions (for example, turning on/off the external electronic device (or some components of the external electronic device) or controlling a brightness of the display) of the external electronic device (104 communicating with the electronic device 101, an application executed in the external electronic device 104, or a service (for example, call service or message service) provided by the external electronic device 104.

According to various embodiments, the application 134 may include an application designated according to an attribute (for example, type of electronic device) of the external electronic device 104. For example, when the external electronic device 104 is an MP3 player, the application 134 may include an application related to music reproduction. Similarly, when the external electronic device 104 is a mobile medical device, the application 134 may include an application related to health care. According to an embodiment, the application 134 may include at least one of an application designated to the electronic device 101 and an application received from an external electronic device (for example, server 106 or electronic device 104).

The input/output interface 140 transmits a command or data input from the user through an input/output device (for example, a sensor, a keyboard, or a touch screen) to the processor 120, the memory 130, the communication interface 160, or the display control module 170 through, for example, the bus 110. For example, the input/output interface 140 may provide data on a user's touch input through a touch screen to the processor 120. Further, the input/output interface 140 may output a command or data received, through, for example, the bus 110, from the processor 120, the memory 130, the communication interface 160, or the display control module 170 through the input/output device (for example, a speaker or a display). For example, the input/output interface 140 may output voice data processed through the processor 120 to the user through the speaker.

The display 150 displays various pieces of information (for example, multimedia data, text data, or the like) for the user. The bus 110 may be a circuit connecting the above described components and transmitting communication (for example, a control message) between the above described components.

The processor 120 receives commands from other components (for example, the memory 130, the input/output interface 140, the display 150, the communication interface 160, or the display control module 170) through the bus 110, analyzes the received commands, and executes calculation or data processing according to the analyzed commands.

The memory 130 stores commands or data received from the processor 120 or other components (for example, the input/output interface 140, the display 150, the communication interface 160, or the display control module 170) or generated by the processor 120 or other components. The memory 130 may include programming modules, for example, a kernel 131, middleware 132, an Application Programming Interface (API) 133, and an application 134. Each of the aforementioned programming modules may be implemented by software, firmware, hardware, or a combination of two or more thereof.

The kernel 131 controls or manages system resources (for example, the bus 110, the processor 120, or the memory 130) used for executing an operation or function implemented by the remaining other programming modules, for example, the middleware 132, the API 133, or the application 134. Further, the kernel 131 provides an interface for accessing individual components of the electronic device 101 from the middleware 132, the API 133, or the application 134 to control or manage the components.

The middleware 132 performs a relay function of allowing the API 133 or the application 134 to communicate with the kernel 131 to exchange data. Further, in operation requests received from the application 134, the middleware 132 performs a control for the operation requests (for example, scheduling or load balancing) by using a method of assigning a priority, by which system resources (for example, the bus 110, the processor 120, the memory 130 and the like) of the electronic device 101 can be used, to the application 134.

The API 133 is an interface by which the application 134 can control a function provided by the kernel 131 or the middleware 132 and includes, for example, at least one interface or function (for example, command) for a file control, a window control, image processing, or a character control.

According to various embodiments, the application 134 may include a Short Message Service (SMS)/Multimedia Messaging Service (MMS) application, an email application, a calendar application, an alarm application, a health care application (for example, application measuring quantity of exercise or blood sugar) or an environment information application (for example, application providing information on barometric pressure, humidity or temperature). Additionally or alternatively, the application 134 may be an application related to an information exchange between the electronic device 101 and an external electronic device (for example, electronic device 104). The application related to the information exchange may include, for example, a notification relay application for transferring particular information to the external electronic device or a device management application for managing the external electronic device.

For example, the notification relay application may include a function of transmitting notification information generated by another application (for example, an SMS/MMS application, an email application, a health care application or an environment information application) of the electronic device 101 to the external electronic device (for example, electronic device 104). Additionally or alternatively, the notification relay application may receive notification information from, for example, the external electronic device 104 and provide the received notification information to the user. The device management application may manage (for example, install, remove, or update) at least a part of functions (for example, turning on/off the external electronic device (or some components of the external electronic device) or controlling a brightness of the display) of the external electronic device (104 communicating with the electronic device 101, an application executed in the external electronic device 104, or a service (for example, call service or message service) provided by the external electronic device 104.

According to various embodiments, the application 134 may include an application designated according to an attribute (for example, type of electronic device) of the external electronic device 104. For example, when the external electronic device 104 is an MP3 player, the application 134 may include an application related to music reproduction. Similarly, when the external electronic device 104 is a mobile medical device, the application 134 may include an application related to health care. According to an embodiment, the application 134 may include at least one of an application designated to the electronic device 101 or an application received from an external electronic device (for example, server 106 or electronic device 104).

The input/output interface 140 transmits a command or data input from the user through an input/output device (for example, a sensor, a keyboard, or a touch screen) to the processor 120, the memory 130, the communication interface 160, or the display control module 170 through, for example, the bus 110. For example, the input/output interface 140 may provide data on a user's touch input through a touch screen to the processor 120. Further, the input/output interface 140 may output a command or data received, through, for example, the bus 110, from the processor 120, the memory 130, the communication interface 160, or the display control module 170 through the input/output device (for example, a speaker or a display). For example, the input/output interface 140 may output voice data processed through the processor 120 to the user through the speaker.

The display 150 displays various pieces of information (for example, multimedia data, text data, or the like) for the user.

The communication interface 160 connects communication between the electronic device 101 and the external device (for example, electronic device 104 or server 106). For example, the communication interface 160 may access a network 162 through wireless or wired communication to communicate with the external device. The wireless communication includes at least one of, for example, WiFi, BlueTooth (BT), Near Field Communication (NFC), a Global Positioning System (GPS), or cellular communication (for example, LTE, LTE-A, CDMA, WCDMA, UMTS, WiBro or GSM). The wired communication may include at least one of, for example, a Universal Serial Bus (USB), a High Definition Multimedia Interface (HDMI), Recommended Standard 232 (RS-232), or a Plain Old Telephone Service (POTS).

According to an embodiment, the network 162 may be a telecommunication network. The telecommunication network includes at least one of a computer network, Internet, Internet of things, or a telephone network. According to an embodiment, a protocol (for example, transport layer protocol, data link layer protocol, or physical layer protocol) for communication between the electronic device 101 and the external device may be supported by at least one of the application 134, the application programming interface 133, the middleware 132, the kernel 131, or the communication interface 160.

According to an embodiment, the server 106 may support the operation of the electronic device 101 by performing at least one of operations (or functions) realized in the electronic device 101. For example, the server 106 may include therein a display control server module 108 that can support the display control module 170 in the electronic device 101. For example, the display control server module 108 may have at least one element of the display control module 170 and thus perform (e.g., substitute) at least one of operations performed by the display control module 170.

According to an embodiment, the electronic device 101 may include the display 150 configured to display at least two display regions, to display an execution screen of an application on one of the at least two display regions, and to detect a touch input event. Also, the electronic device 101 may include the display control module 170 configured to control the display 150 to display the at least two display regions on a single screen 200, to control the display 150 to display the execution screen of the application on one of the at least two display regions, and to control the display 150 to display a user interface 500 corresponding to an input event on a specific display region selected from among the at least two display regions according to a predefined policy when the display 150 detects the input event for displaying the user interface 500.

According to an embodiment, when the input event for displaying the user interface is detected through the input/output interface 140 (e.g., a touch screen, a sensor, etc.), the display control module 170 may control the display 150 to display the user interface.

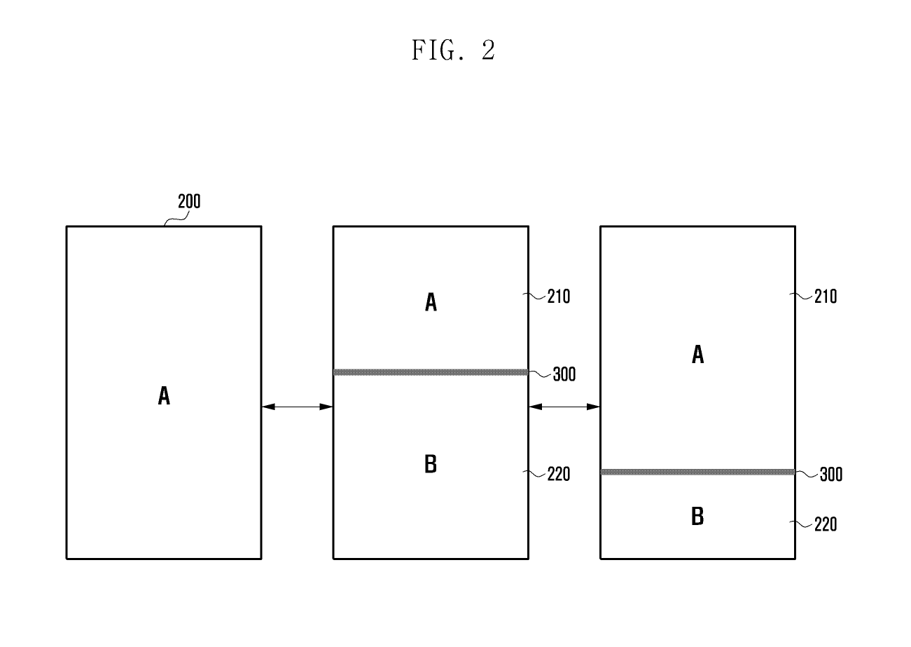

The display control module 170 may process at least part of information obtained from the other elements (e.g., the processor 120, the memory 130, the input/output interface 140, the display 150, the communication interface 160, etc.) and offer it to a user in various manners. For example, using the processor 120 or independently of the processor 120, the display control module 170 may control at least parts of functions of the electronic device 101 such that the electronic device 101 can interwork with any other electronic device (e.g., the electronic device 104 or the server 106). In an embodiment, at least one element of the display control module 170 may be incorporated in the server 106 (e.g., the display control server module 108), and the server 106 may support at least one operation of the display control module 170. Detailed information about the display control module 170 will be given below through FIGS. 2 to 16.

In an embodiment, the display control module 170 may control the screen 200 to display at least two display regions. In an embodiment, the display control module 170 may control screens associated with various functions (or applications) executed in the electronic device 101 to be displayed on an assigned display region among display regions. The display control module 170 may offer such display regions, based on a predefined screen division policy.

In an embodiment, the display control module 170 may control a screen display function of the display 150 and thereby display the execution screen of each application through each corresponding display region. In this case, the display 150 may simultaneously display divided individual screens on the respective display regions.

In an embodiment, the display control module 170 may control the display 150 to display thereon a separator 300 for separating the display regions, a tray or application launcher (not shown) for invoking a desired application effectively and intuitively, a virtual input device (e.g., a touch keypad or floating keypad, not shown) that freely moves on the screen 200, and the like.

In an embodiment, when the input/output interface 140 detects a user's input from the entire screen or the individual display region, this input signal may be transferred to the display control module 170.

In an embodiment, the display 150 may support a screen display in either a landscape mode or a portrait mode, depending on a rotation direction or placed orientation of the electronic device 101. In this disclosure, the landscape mode refers to a state where the electronic device 101 is placed widthwise and thus offers a wide display view. Additionally, the portrait mode refers to a state where the electronic device 101 is placed lengthwise and thus offers a long display view.

In an embodiment, the display control module 170 may control the screen 200 to display, on a certain display region, the user interface 500 in the form of a list and also display a scroll bar 600 to scroll in the user interface 500. For example, in case contents or items of the user interface 500 cannot be displayed at a time, the scroll bar 600 may be additionally used.

In an embodiment, in case the display 150 and a touch panel for detecting a touch gesture form together a multi-layer structure, the display 150 may be used, together with the input/output interface 140, as both an input device and an output device. The touch panel may be configured to convert a pressure applied to a specific spot of the display 150 or a variation in capacitance generated at a specific spot of the display 150 into an electric input signal. The touch panel may be configured to detect a touch pressure as well as a touch position and area. When any touch input occurs on the touch panel, a corresponding signal is transferred to a touch controller (not shown). The touch controller may process the received signal and transmit corresponding data to the display control module 170. Therefore, the display control module 170 can ascertain which spot of the display 150 is touched.

In an embodiment, the display control module 170 may control a series of operations for supporting the function of the screen 200. For example, the display control module 170 may control the operation of respectively displaying two or more applications, selected from among running applications, on the corresponding display regions of the screen 200.

For example, the display control module 170 may control the screen 200 to be configured to have a plurality of display regions according to a predetermined screen division policy. In this disclosure, such display regions will be referred to as the first display region 210, the second display region 220, the third display region 230, etc. regardless of order.

When the display 150 detects a touch event input for executing an application, the display control module 170 may control the display 150 to display the execution screen of the application on a specific display region selected from among the display regions.

In an embodiment, when the display 150 detects an input event for triggering the user interface 500, the display control module 170 may control the display 150 to display the user interface 500 on a specific display region determined according to a predefined policy.

The user interface 500 may include at least one of a menu UI (user interface) used for invoking a selected function, a text input UI used for entering a text input, a keypad input UI used for entering a numeric input, a pop-up UI for offering information, or a notification UI for offering a notification.

In an embodiment, the display control module 170 may control the display 150 to display the user interface 500 on a display region from which the input event is not detected. For example, if any input event is detected from the second display region 220, the display control module 170 may control the display 150 to display the user interface 500 on the first display region 210.

In an embodiment, the display control module 170 may determine whether each display region is activated or inactivated. Then, based on the result of determination, the display control module 170 may control the display 150 to display the user interface 500 on the inactivated display region.

For example, the display control module 170 may determine the activation of each display region by checking whether the display region receives the last input event, whether any application is running continuously in the display region, and the like. Specifically, if a video application is running in the first display region 210 and if a memo application is running in the second display region 220, the display control module 170 may determine that the first display region 210 having a real-time change in screens is an activated display region. Therefore, the second display region 220 may be determined as an inactivated display region.

In an embodiment, the display control module 170 may control the user interface 500 to be displayed on the inactivated display region. If it is checked that there is a user's touch input event in the first display region 210, the display control module 170 may determine the second display region 220 as being inactivated and then control the user interface 500 to be displayed on the second display region 220.

In an embodiment, if the display 150 detects a selection input event for selecting a display region for displaying the user interface 500, the display control module 170 may select the display region for the user interface 500 in response to the selection input event. For example, if a user selects the first display region 210 as a display region for displaying the user interface 500, the display control module 170 may control the user interface 500 to be displayed on the first display region 210. In this case, the display control module 170 may change a display region for the user interface 500 from the first display region 210 to the second display region 220 in response to a user's command.

In an embodiment, when the display 150 detects a move input event (e.g., a drag and drop input event, a flick input event, etc.) for moving the user interface 500 from the selected display region to a new display region, the display control module 170 may move the user interface 500 to the new display region in response to the detected move input event. For example, if the user interface 500 is displayed on the first display region 210, the display control module 170 may control the user interface 500 to be displayed on the second display region 220 in response to a user's input (e.g., a touch-based input event, a drag and drop input event, etc.) for moving the user interface 500. In this disclosure, a touch-based input event may include a swipe touch input event, a drag-and-drop input event, a flick input event, a flip input event, and the like.

In an embodiment, the display control module 170 may determine whether there is a display region that does not display (or fails to display) the execution screen of an application or there is a display region in which a predetermined time has passed after detection of the input event. Then, based on the result of determination, the display control module 170 may select a specific display region and control the user interface 500 to be displayed on the selected display region.

For example, in case the screen 200 is formed of four display regions, the display 150 may display the execution screens of applications on three display regions. Then, if the display 150 detects an input event for invoking a new application or triggering the user interface 500, the display control module 170 may control the execution screen of the new application or the user interface 500 to be displayed on an empty display region which currently displays no application.

For example, the display control module 170 may compare the activation status (or priority) of the display regions. Namely, the activation status or priority may be determined depending on the last touch input time, whether a display view is changed continuously, or the like. Based on the result of this determination, the display control module 170 may control the user interface 500 or the execution screen of an application to be displayed on a specific display region having the lowest, or relatively lower, activation status or priority.

For example, if the display 150 displays a video player screen on the first display region 210, displays an SNS screen on the second display region 220, displays an e-book page or related screen on the third display region 230, and displays an internet web page on the fourth display region 240, and if the last touch input event is detected from the third display region 230, the display control module 170 may determine the fourth display region 240 as a display region for displaying the user interface 500 or the like. Namely, since the first and second display regions 210 and 220 have a specific function executed in real time and since the third display region 230 receives a touch input event, the fourth display region has the lowest activation priority in this case.

In an embodiment, the display control module 170 may determine whether there is a display region in which a predetermined time has passed after the last input event was detected. If there is such a display region, the display control module 170 may control the user interface 500 to be displayed on that display region. In this case, a predetermined time may be set in advance by a user, manufacturer, or developer.

In an embodiment, when the display 150 detects an input event from the quick panel 400 that offers status information of the electronic device and/or certain notification information, the display control module 170 may control a full screen of the quick panel 400 to be displayed on a specific display region determined in response to the detected input event. In this disclosure, the quick panel 400 has a function to simply indicate status information, notification information, etc. regarding the electronic device 101 and also to selectively display such information in response to a predefined input event. Using the quick panel 400, a user can check quickly the current status or the like of the electronic device 101.

In an embodiment, the display 150 may detect an input event (e.g., a drag and drop input event, a flick input event, etc.) from the quick panel 400. For example, the display 150 may detect a touch-based input event that occurs at the quick panel 400 and is then released from one of the display regions. Then the display control module 170 may determine the touch-released display region as a display region for displaying a full screen of the quick panel 400, and control the full screen of the quick panel 400 to be displayed on the determined display region.

In an embodiment, the display 150 may receive a notification signal for offering notification information after the full screen of the quick panel 400 is displayed on the determined display region. Then the display control module 170 may control a notification UI corresponding to the received notification signal to be displayed on the determined display region. In this case, a notification signal may be a signal containing information associated with a particular function (e.g., SNS message, text message, etc.) selected by a user.

Thereafter, in an embodiment, when the display 150 detects a touch input event from the notification UI, the display control module 170 may control a full screen of the notification UI to be displayed on the determined display region in response to the detected touch input event.

In an embodiment, if any input event for requesting the execution of a new application is detected while some applications are displayed on corresponding display regions, the display control module 170 may execute the new application through a selected display region. At this time, the display control module 170 may send a former application, which has been executed through the selected display region, to the background and then allow the new application to be displayed on the selected display region.

The display control module 170 may control operations of displaying and moving the tray (not shown), the separator 300, the floating keypad (not shown), etc. on the screen 200. For example, the display control module 170 may change a size of each display region in response to the movement of the separator 300.

In an embodiment, the screen 200 may offer the tray (not shown) for supporting a quick execution of an application through each display region. This tray may include execution icons (or shortcut icons) of all executable applications installed in the electronic device 101 or of some applications selected by a user's setting. The tray may be displayed (i.e., slide in) on the screen or hidden (i.e., slide out) from the screen. The tray may have a handle item for receiving a slide-in command from a user in a slide-out state.

In an embodiment, the tray may support a scroll of execution icons therein, and such execution icons in the tray may be modified, added or deleted in response to a user's selection. The tray may be arranged in two or three rows, which may be varied according to a user's setting.

According to various embodiments, the electronic device 101 may include the display 150 configured to display at least two display regions, to display an execution screen of an application on one of the at least two display regions, and to detect an input event for displaying the user interface 500. Also, the electronic device 101 may include the display control module 170 configured to control the display 150 to display the at least two display regions on a single screen, to control the display 150 to display the execution screen of the application on one of the at least two display regions, and to control the display 150 to display the user interface 500 corresponding to the input event on a specific display region selected from among the at least two display regions according to a predefined policy.

According to various embodiments, the display control module 170 may be further configured to control the display 150 to display the user interface 500 on a display region from which the input event is not detected. Additionally, the display control module 170 may be further configured to determine whether each of the at least two display regions is activated or inactivated, and based on the result of determination, to control the display 150 to display the user interface 500 on the inactivated display region.

According to various embodiments, the display control module 170 may be further configured, when the display 150 detects a selection input event for selecting a display region to be used for displaying the user interface 500, to select the display region in response to the selection input event, and to control the display 150 to display the user interface on the selected display region. The user interface may include at least one of a menu UI (user interface) used for invoking a selected function, a text input UI used for entering a text input, a keypad input UI used for entering a numeric input, a pop-up UI for offering information, or a notification UI for offering a notification.

According to various embodiments, the display 150 may be further configured to identify individual functions offered by the user interface 500, and to display the user interface 500 in the form of a list in which several items linked to the identified functions are arranged, or to display the scroll bar 600 to scroll in the user interface 500.

According to various embodiments, the display control module 170 may be further configured, when the display 150 detects a move input event for moving the user interface 500 from the selected display region to a new display region, to move the user interface 500 to the new display region in response to the detected move input event.

According to various embodiments, the display control module 170 may be further configured to determine whether there is a display region that fails to display the execution screen of the application or there is a display region in which a predetermined time has passed after detection of the input event, to select the specific display region based on the result of determination, to control the display 150 to display the user interface 500 on the selected display region.

According to various embodiments, the display control module 170 may be further configured, when the display 150 detects an input event from the quick panel 400 that offers status information of the electronic device, to control the display 150 to display a full screen of the quick panel 400 on a specific display region determined in response to the detected input event. In an embodiment, the display control module 170 may be further configured, when the display 150 detects a touch-based input event that occurs at the quick panel 400 and is then released from one of the display regions, to select the touch-released display region as a particular display region to be used for displaying the full screen of the quick panel 400, and to control the display 150 to display the full screen of the quick panel 400 on the selected display region.

In an embodiment, the display control module 170 may be further configured, when the display 150 receives a notification signal for offering notification information after the full screen of the quick panel 400 is displayed, to control the display 150 to display a notification UI corresponding to the received notification signal on the selected display region. In an embodiment, the display control module 170 may be further configured, when the display 150 detects a touch input event from the notification UI, to control the display 150 to display a full screen of the notification UI on the selected display region in response to the detected touch input event.

According to various embodiments, in a computer-readable storage medium which records thereon various commands, the commands are defined to enable at least one processor to perform at least one operation when being executed by the processor. The operation may include displaying at least two display regions; displaying an execution screen of an application on one of the at least two display regions; detecting an input event for displaying a user interface; and displaying the user interface corresponding to the input event on a specific display region selected from among the at least two display regions according to a predefined policy.

FIG. 2 is a schematic diagram illustrating a display control of an electronic device in accordance with various embodiments of the present disclosure.

Referring to FIG. 2, in various embodiments of this disclosure, a display screen 200 may include therein at least two display regions 210 and 220 and a separator 300 for separating the display regions and also adjusting a size of each display region. In each display region, operations (e.g., a navigation, a scroll, a text input, etc.) associated with the execution of a corresponding application may be performed independently without regard to the other display region. The display regions may be referred to as the first display region 210, the second display region 220, and the like. In some embodiments, the screen 200 may further include a pop-up window (not shown) having an additional interface (e.g., a memo interface).

Although FIG. 2 shows two display regions 210 and 220 (i.e., execution regions) separated by one separator 300, this is used as an example and not to be construed as a limitation of this disclosure. In other embodiments, the screen 200 may be divided into “N” display regions (with “N” being a natural number greater than one), depending on the size thereof. Similarly, the screen 200 may offer one or more separators 300 based on the number of display regions. For example, as shown in FIG. 2, two display regions 210 and 220 need the single separator 300. In other examples, three display regions may need two separators, and four display regions may need two or three separators.

At the outset, the display (150 in FIG. 1) may display an application “A” on a full screen 200 as shown in FIG. 2. If another application “B” is invoked while the application “A” is running on the full screen 200, the display 150 may trigger the separator 300 to divide the screen 200 into two display regions 210 and 220, which offer respective screens of the applications “A” and “B”. For example, the display 150 may display the application “A” on the first display region 210 and also display the application “B” on the second display region 220. Like this, according to embodiments of the present disclosure, two or more applications can be controlled simultaneously through at least two display regions.

According to an embodiment, the display 150 may display a size-adjusted display region. For example, by moving (e.g., via a touch and drag) the separator 300, a user can adjust sizes of the first and second display regions 210 and 220 in which the applications “A” and “B” are executed respectively. In an embodiment, when the size of a certain display region is adjusted through the movement of the separator 300, the display control module 170 may also adjust a screen size of a corresponding application depending on the size-adjusted display region.

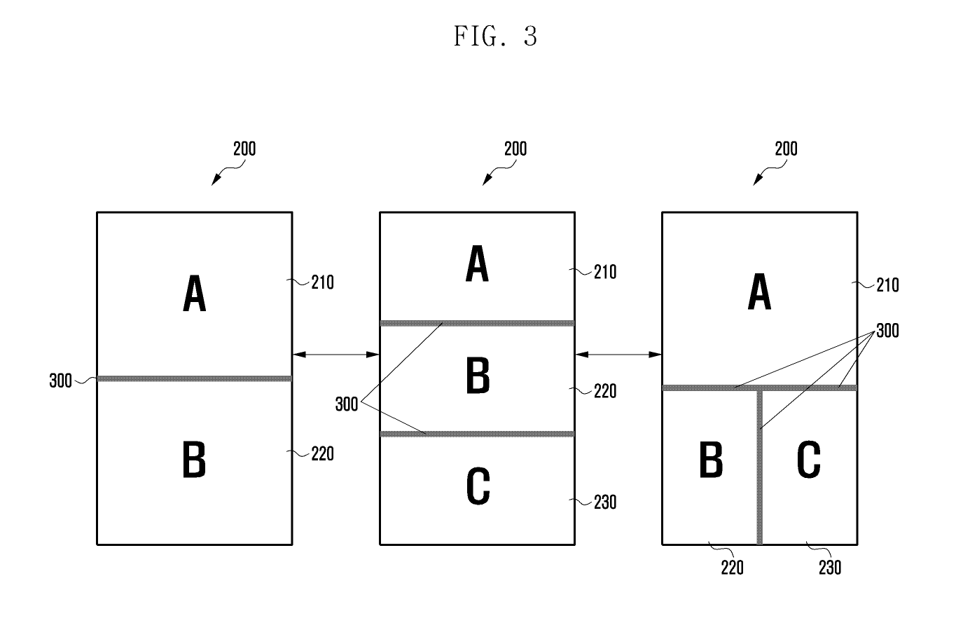

FIG. 3 is a schematic diagram illustrating another display control of an electronic device in accordance with various embodiments of the present disclosure.

Referring to FIG. 3, the display 150 may display, on the screen 200, two display regions 210 and 220 divided by the separator 300 and corresponding to the applications “A” and “B”, respectively.

According to an embodiment, the third application “C” may be further executed when the first and second applications “A” and “B” are running. In this case, the display 150 may trigger two separators 300 to divide the screen 20 into three display regions 210, 220 and 230, which offer respective screens of the applications “A”, “B” and “C”. Such a screen division can be performed in various forms, shapes or directions (e.g., lengthwise, widthwise, diagonally, etc.), based on a screen division policy depending on a user's setting or predefined as a default.

For example, the display 150 may divide the screen 200 into three parts in a lengthwise direction and then dispose three display regions 210, 220 and 230 to upper, middle and lower parts, respectively. In another example, the display 150 may divide the screen 200 into two parts (i.e., upper and lower parts) in a lengthwise direction and further divide one part (e.g., the lower part) into two sub-parts (i.e., left and right parts) in a widthwise direction. Then the display 150 may dispose three display regions 210, 220 and 230 to upper, lower left and lower right parts, respectively.

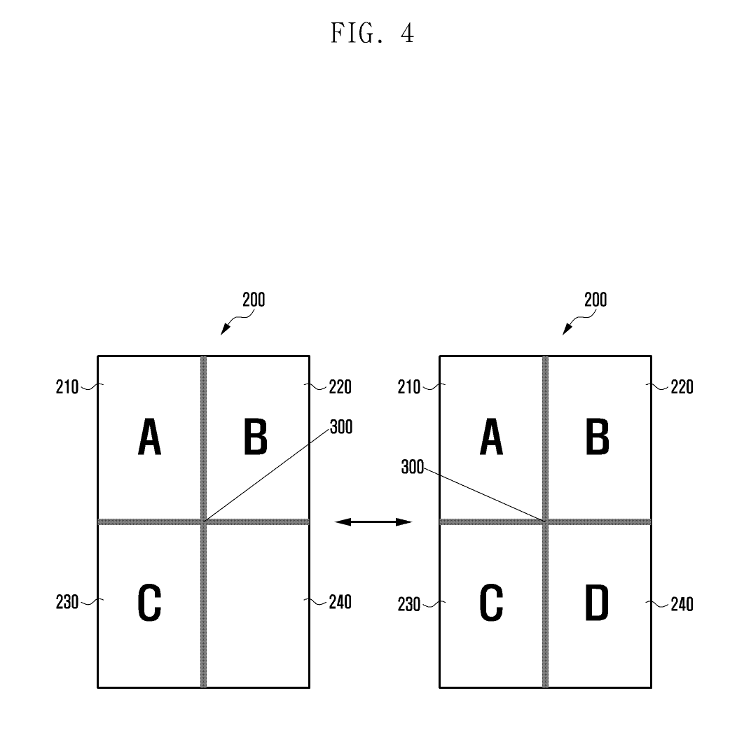

FIG. 4 is a schematic diagram illustrating still another display control of an electronic device in accordance with various embodiments of the present disclosure.

Referring to FIG. 4, in some embodiments, the display 150 may display four display regions 210, 220, 230 and 240 by dividing the screen 200 through two or more separators 300. In this case, if three applications “A”, “B” and “C” are running, three display regions are assigned to display such applications and the other display region remains as an empty region.

In an embodiment, such an empty region (e.g., 240) may be determined or set depending on a user's setting or predefined as a default. Additionally, the display control module 170 may determine the activation priority of each display region. Then, based on such activation priority, the display control module 170 may assign the respective display regions to running applications, a user interface, an empty region, and the like.

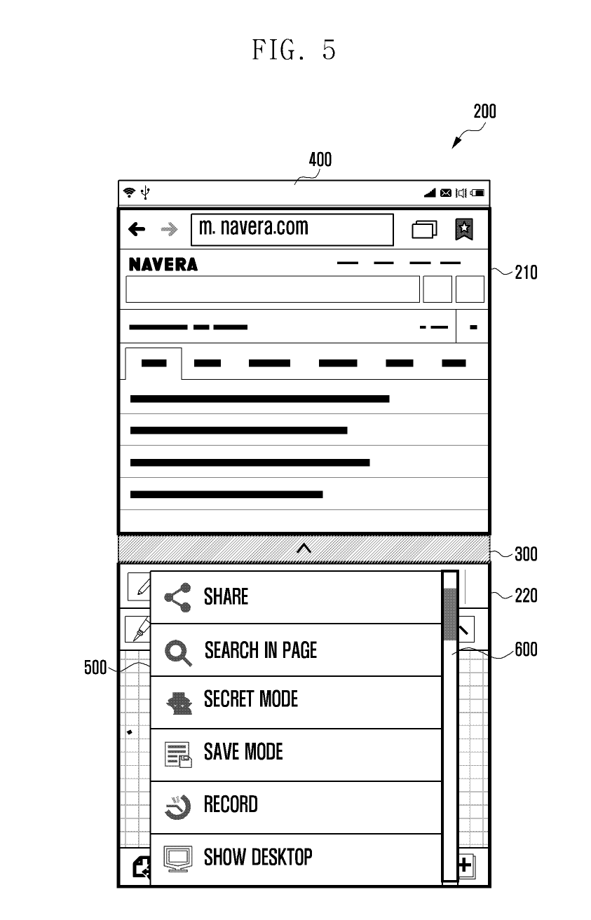

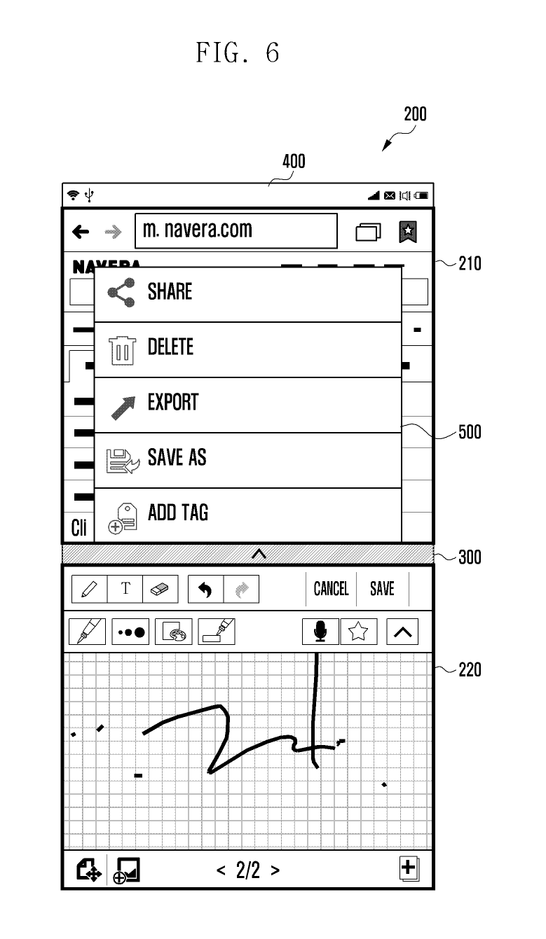

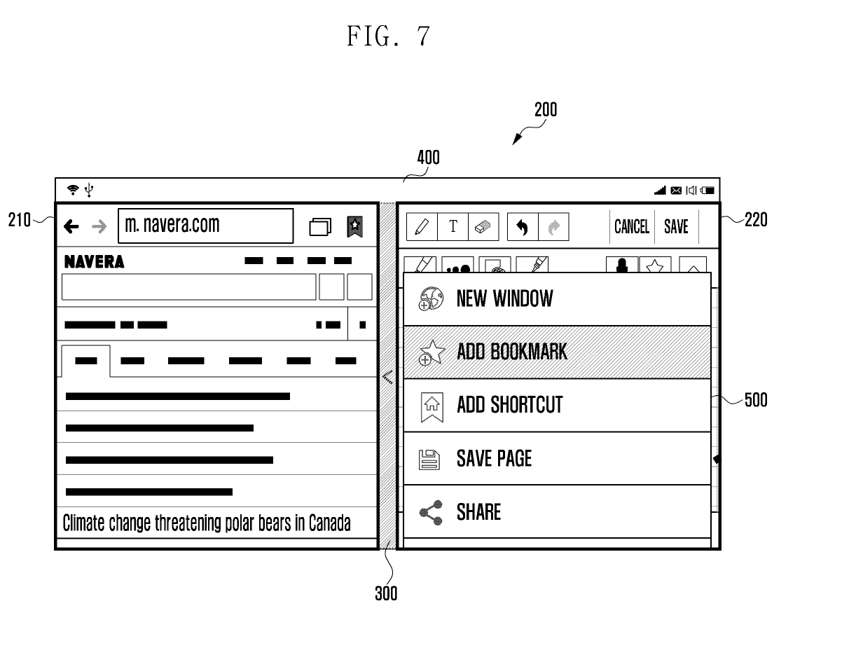

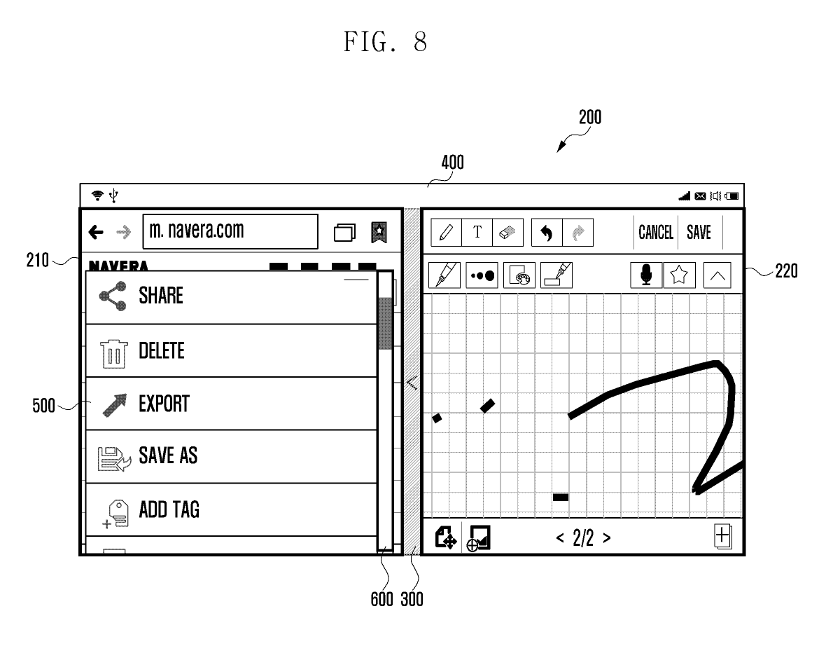

For example, the display 150 may display a video player screen on the first display region 210, display an SNS screen on the second display region 220, display an e-book page or related screen on the third display region 230, and display an internet web page on the fourth display region 240. In this case, if the final touch input event is detected from the third display region 230, the display control module 170 may determine or set the fourth display region 240 as a display region for displaying a user interface (e.g., 500 in FIG. 5). The reason is that the each display region may be assigned an activation priority based on the functions executing therein, and in this example, the first and second display regions 210 and 220 have a specific function executed in real time, and that the third display region 230 receives a touch input event. Thus, the fourth display region may be determined to have the lowest activation priority in this case, and so the user interface may be displayed therein.

FIGS. 5 to 8 are screenshots illustrating examples of displaying additional information on a screen in accordance with various embodiments of the present disclosure.

According to embodiments, the display 150 may display at least one of the first display region 210, the second display region 220, the separator 300, a quick panel 400, a user interface 500, and/or a scroll bar 600. For example, based on a predefined policy or preconfigured setting, the display control module 170 may divide the screen 200 into at least two display regions.

Referring to FIGS. 5 to 8, the display 150 may display an application screen on each of the first and second display regions 210 and 220. If the display 150 detects a predetermined input event for triggering a user interface, the display control module 170 may display the user interface 500 on a specific display region determined by the above-discussed activation priority. In this case, the input event may be detected through the display 150 and/or the input/output interface 140.

The user interface 500 may include at least one of a menu UI used for invoking a selected function, a text input UI used for entering a text input, a keypad input UI used for entering a numeric input, a pop-up UI for offering information, or a notification UI for offering a notification.

According to an embodiment, the display control module 170 may determine whether each display region is activated or inactivated. For example, if a certain display region receives no input event for a given time, this display region may be determined as being inactivated. The display control module 170 may assign the user interface 500 to such an inactivated display region and also control the display 150 to display the user interface 500 on the inactivated display region.

Alternatively, in case the display 150 detects, from a certain display region, a predetermined input event for selecting the display region for the user interface 500, the display control module 170 may control the display 150 to display the user interface 500 on the selected display region.

FIG. 5 is a screenshot illustrating an example of displaying additional information on a screen in accordance with various embodiments of the present disclosure.

Referring to FIG. 5, the display 150 may display respective applications on corresponding display regions (e.g., the first and second display regions 210 and 220). If the display 150 detects a predefined input event for triggering the user interface 500, the display control module 170 may display the user interface 500 on a specific display region determined according to a predefined policy.

For example, in case the screen 200 is in a portrait mode, the display control module 170 may determine the first display region 210 as being activated or receiving the user's last input event. Then, if an input event for triggering the user interface 500 is detected, the display control module 170 may control the display 150 to display the user interface 500 on the second display unit 220. In an embodiment, the display 150 may display the user interface 500 in the form of a list in which several items linked to specific functions are arranged. Additionally, the display 150 may further display the scroll bar 600 to scroll in the user interface 500.

FIG. 6 is a screenshot illustrating another example of displaying additional information on a screen in accordance with various embodiments of the present disclosure.

Referring to FIG. 6, the display 150 may display respective applications on corresponding display regions (e.g., the first and second display regions 210 and 220). If the display 150 detects a predefined input event for triggering the user interface 500, the display control module 170 may display the user interface 500 on a specific display region determined according to a predefined policy.

For example, in case the screen 200 is in a portrait mode, the display control module 170 may determine the second display region 220 as being activated or receiving the user's last input event. Then, if an input event for triggering the user interface 500 is detected, the display control module 170 may control the display 150 to display the user interface 500 on the first display unit 210. In an embodiment, the display 150 may display the user interface 500 in the form of a list in which several items linked to specific functions are arranged.

FIG. 7 is a screenshot illustrating still another example of displaying additional information on a screen in accordance with various embodiments of the present disclosure.

Referring to FIG. 7, the display 150 may display respective applications on corresponding display regions (e.g., the first and second display regions 210 and 220). If the display 150 detects a predefined input event for triggering the user interface 500, the display control module 170 may display the user interface 500 on a specific display region determined according to, for example, a predefined policy.

In one example, when the screen 200 is in a landscape mode, the display control module 170 may determine the first display region 210 as activated or, in other words, having received the user's last input event. Then, if an input event for triggering the user interface 500 is detected, the display control module 170 may control the display 150 to display the user interface 500 on the second display unit 220. In an embodiment, the display 150 may display the user interface 500 in the form of a list, on which several items linked to specific functions are arranged.

FIG. 8 is a screenshot illustrating yet another example of displaying additional information on a screen in accordance with various embodiments of the present disclosure.

Referring to FIG. 8, the display 150 may display respective applications on corresponding display regions (e.g., the first and second display regions 210 and 220). If the display 150 detects a predefined input event for triggering the user interface 500, the display control module 170 may display the user interface 500 on a specific display region determined according to a predefined policy.

For example, when the screen 200 is in a landscape mode, the display control module 170 may determine the second display region 220 as activated or receiving the user's last input event. Then, if an input event for triggering the user interface 500 is detected, the display control module 170 may control the display 150 to display the user interface 500 on the first display unit 210. In an embodiment, the display 150 may display the user interface 500 in the form of a list on which several items linked to specific functions are arranged. Additionally, the display 150 may further display the scroll bar 600 to facilitate scrolling the user interface 500.

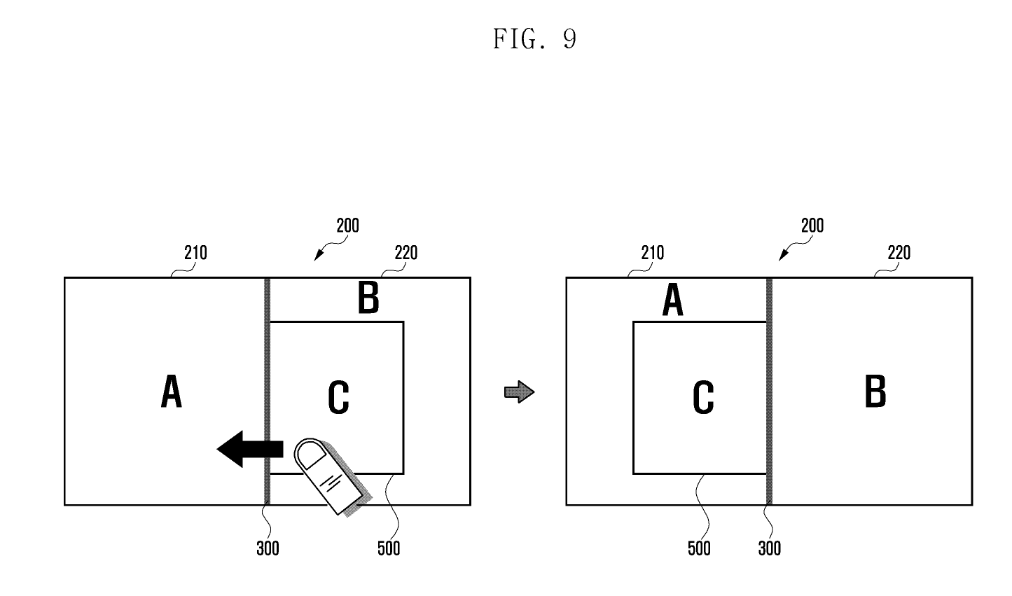

FIG. 9 is a schematic diagram illustrating a move of a user interface on a screen in accordance with various embodiments of the present disclosure.

Referring to FIG. 9, the display 150 may display the execution screens of respective applications on at least two display regions (e.g., the first and second display regions 210 and 220).

In an embodiment, if the display 150 detects an input event for moving the user interface 500 from one display region to another display region, the display control module 170 may control the display 150 to display the user interface 500 on the latter display region determined in response to the detected input event. In this case, the input event for a move of the user interface 500 may be based on a touch and drag gesture, specifically, touching the user interface and also dragging, swiping, flipping, or flicking the touched user interface to or toward a target display region.

For example, a user may touch a certain spot on the user interface 500 and also drag it toward a certain direction on the screen 200. Then, in response to this touch and drag input, the electronic device 101 may offer a suitable UI or GUI for showing that the user interface 500 leaves, moves or otherwise escapes from a current frame and moves according to a direction of the drag input. If the user interface 500 moves more than a given range (e.g., beyond the separator 300), the user interface 500 may be displayed on the target display region.

For example, as shown in FIG. 9, the display 150 may display the execution screen of the application “A” on the first display region 210 and also display the execution screen of the application “B” on the second display region 220. Further, the display 150 may display the user interface “C” 500 on the second display region 220. If the display 150 detects an input event (e.g., a swipe gesture, a flip gesture, a flick gesture, any other predetermined gesture, or any predefined input action through the input/output interface 140) for moving the user interface 500 to the first display region 210, the display control module 170 may control the display 150 to display the user interface 500 on the first display region 210.

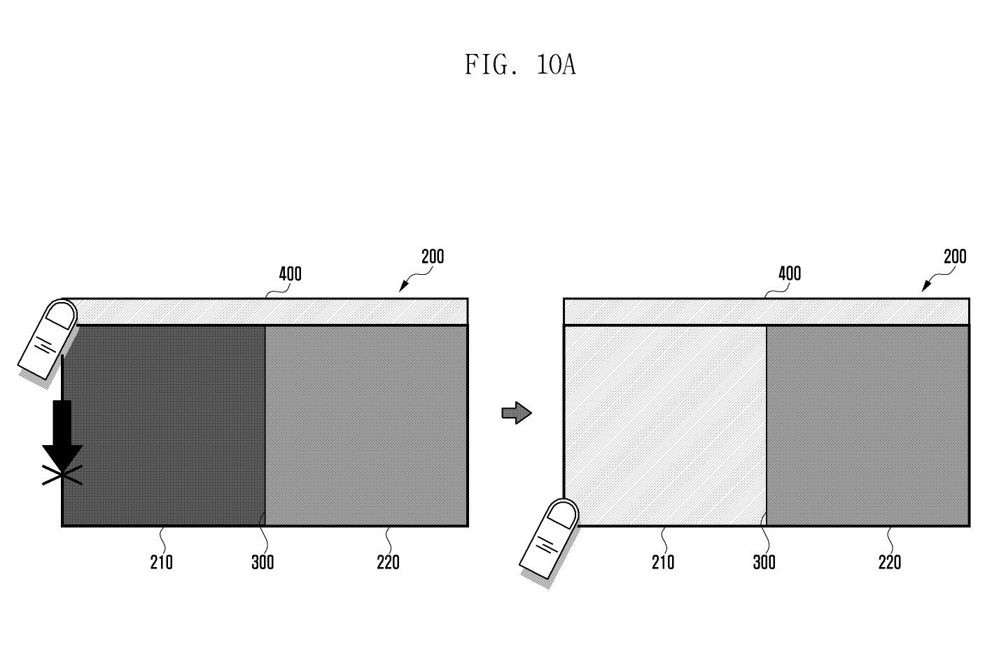

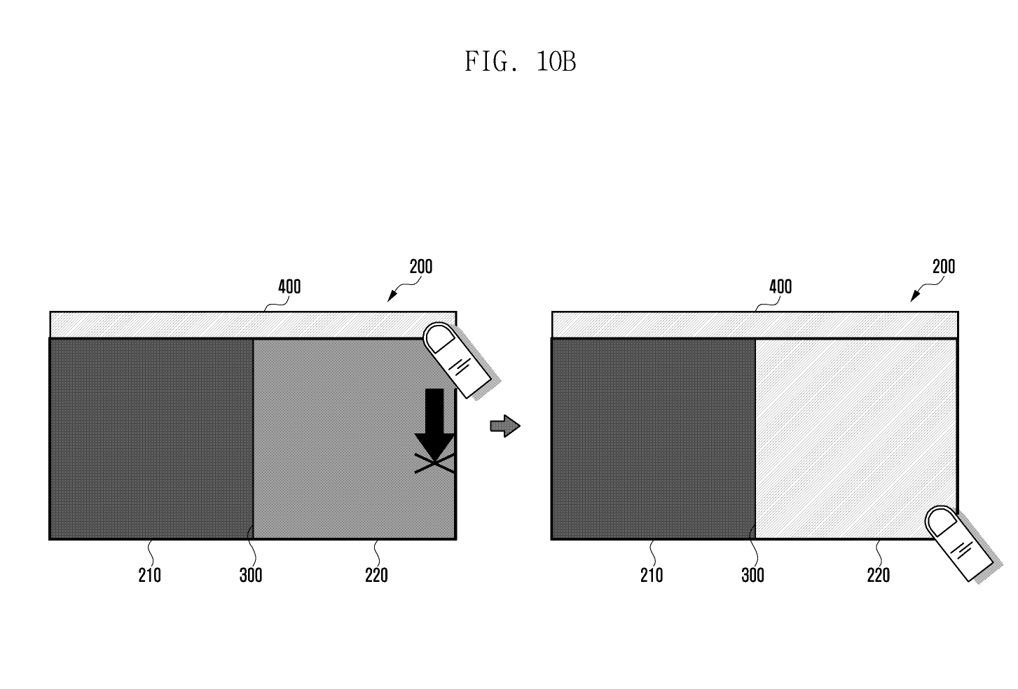

FIGS. 10A to 11B are schematic diagrams illustrating examples of displaying a quick panel on a screen in accordance with various embodiments of the present disclosure.

According to embodiments, the display 150 may display at least one of the first display region 210, the second display region 220, the separator 300, or the quick panel 400. In this disclosure, the quick panel 400 refers to a specific display region that offers various types of information including the status of the electronic device 101, a notification, a battery state, SNS information, weather information, camera information, stock information, and the like.

According to an embodiment, the display 150 may display at least two display regions. Namely, the display control module 170 may configure the screen 200 to have at least two display regions on the basis of a predetermined screen division policy. For example, the display control module 170 may control the display 150 to display the execution screen of the first application on the first display region 210 and also display the execution screen of the second application on the second display region 220.

In an embodiment, if the display 150 detects an input event from the quick panel 400 that indicates status information about the electronic device 101, certain notification information, and the like, the display 150 may display a full screen of the quick panel 400 on a particular display region selected in response to the detected input event.

For example, if the display 150 detects a touch-based input event that occurs at the quick panel 400 and is then released (i.e., a drop input event) from one of the display regions, the display control module 170 may select the touch-released display region as the above-mentioned particular display region. Then the display control module 170 may control the display 150 to display a full screen of the quick panel 400 on the selected display region.

For example, in case the first and second display regions 210 and 220 are displayed together with the separator 300 and the quick panel 400, the display 150 may receive a touch-based input event that occurs at the quick panel 400 and is then released from one of the first and second display regions 210 and 220. Then the full screen of the quick panel 400 may be displayed on the specific display region from which the touch-based input event is released.

Referring to FIG. 10A, when the electronic device 101 is in a landscape mode, the display 150 may receive an input event that occurs at the quick panel 400 and is released from the first display region 210. Then, based on this input event, the display control module 170 may control the display 150 to display the full screen of the quick panel 400 on the first display region 210.

Referring to FIG. 10B, when the electronic device 101 is in a landscape mode, the display 150 may receive an input event that occurs at the quick panel 400 and is released from the second display region 220. Then, based on this input event, the display control module 170 may control the display 150 to display the full screen of the quick panel 400 on the second display region 220.

Referring to FIG. 11A, when the electronic device 101 is in a portrait mode, the display 150 may receive an input event that occurs at the quick panel 400 and is released from the first display region 210. Then, based on this input event, the display control module 170 may control the display 150 to display the full screen of the quick panel 400 on the first display region 210.

Referring to FIG. 11B, when the electronic device 101 is in a portrait mode, the display 150 may receive an input event that occurs at the quick panel 400 and is released from the second display region 220. Then, based on this input event, the display control module 170 may control the display 150 to display the full screen of the quick panel 400 on the second display region 220.

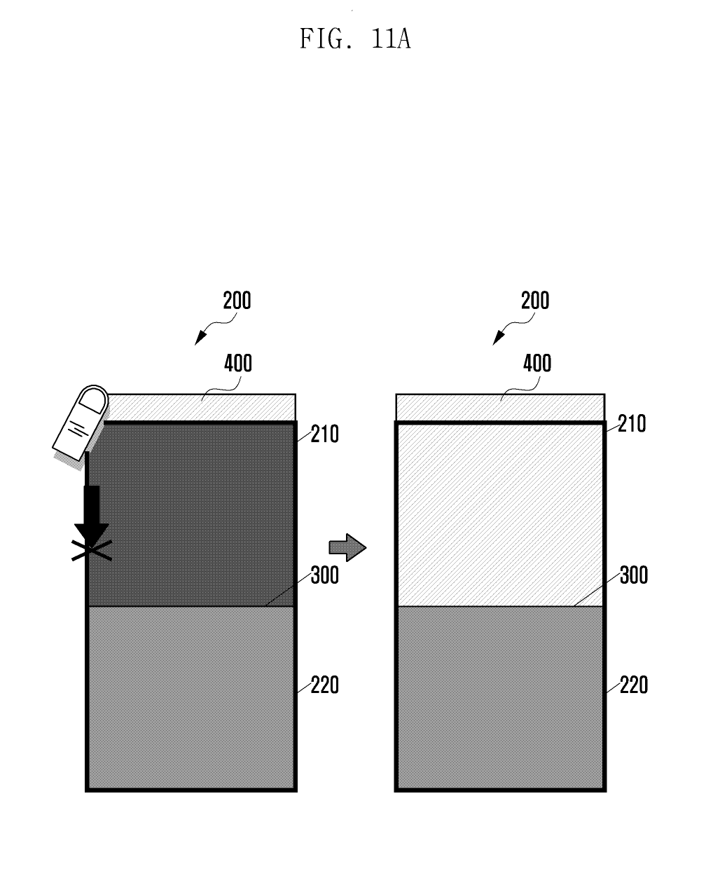

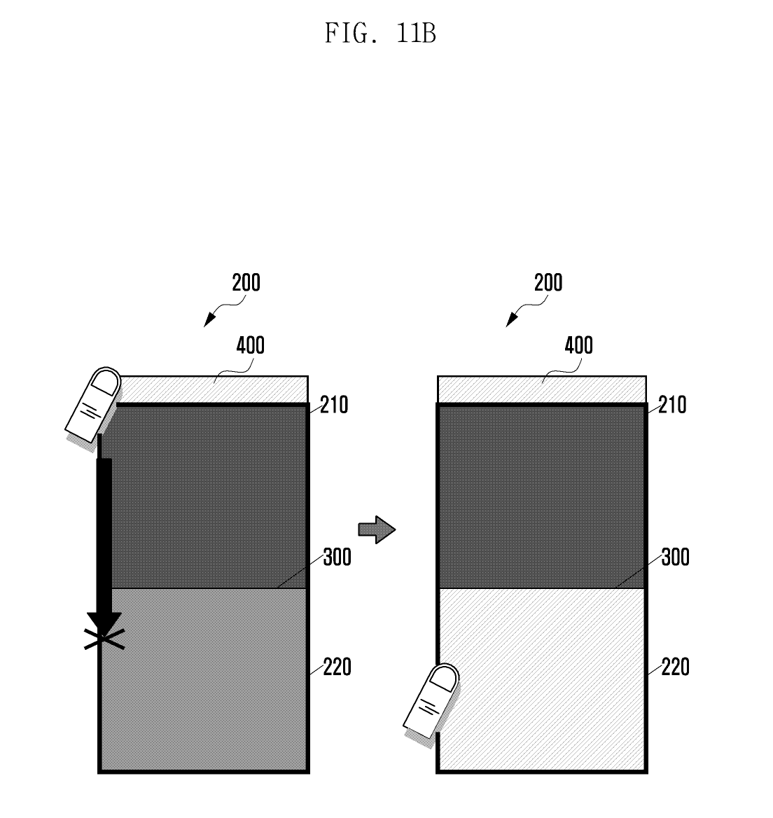

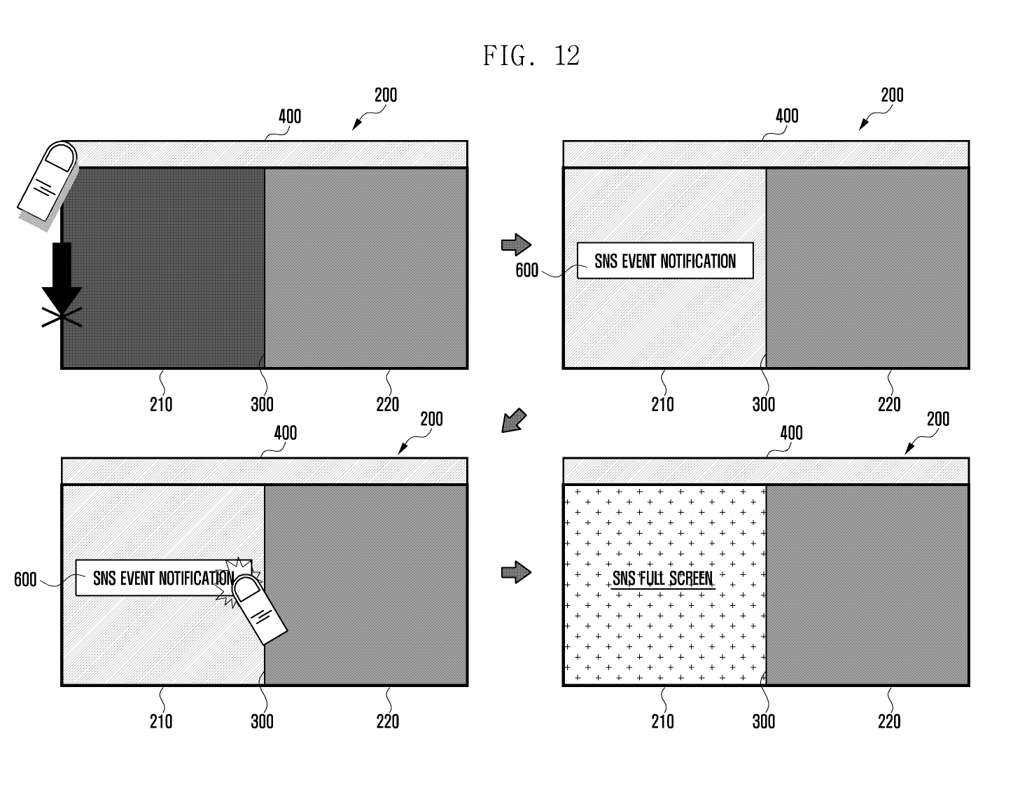

FIG. 12 is a schematic diagram illustrating an example of displaying a notification UI on a screen in accordance with various embodiments of the present disclosure.

According to embodiments, the display 150 may display at least one of the first display region 210, the second display region 220, the separator 300, or the quick panel 400. As mentioned above, the quick panel 400 refers to a specific display region that offers various types of information including the status of the electronic device 101, a notification, a battery state, SNS information, weather information, camera information, stock information, and the like.

According to an embodiment, the display 150 may display at least two display regions. Namely, the display control module 170 may configure the screen 200 to have at least two display regions on the basis of a predetermined screen division policy. For example, the display control module 170 may control the display 150 to display the execution screen of the first application on the first display region 210 and also display the execution screen of the second application on the second display region 220.

In an embodiment, if the display 150 detects an input event from the quick panel 400 that indicates status information about the electronic device 101, certain notification information, and the like, the display 150 may display a full screen of the quick panel 400 on a particular display region selected in response to the detected input event.

In an embodiment, if the display 150 detects a touch-based input event that occurs at the quick panel 400 and is then released (i.e., a drop input event) from one of the display regions, the display control module 170 may select the touch-released display region as the above-mentioned particular display region. Then the display control module 170 may control the display 150 to display a full screen of the quick panel 400 on the selected display region.

In an embodiment, after the full screen of the quick panel 400 is displayed on the selected display region, the display control module 170 may receive a notification signal that offers certain notification information. Then the display control module 170 may control the display 150 to display a notification UI corresponding to the received notification signal on the selected display region.

In an embodiment, when the display 150 receives a touch input event from the notification UI, the display control module 170 may control the display 150 to display a full screen of the notification UI on the selected display region in response to the received touch input event.

For example, referring to FIG. 12, if the display 150 may receive a touch-based input event that occurs at the quick panel 400 and is then released from the first display region 210, the display control module 170 may control the display 150 to display the full screen of the quick panel 400 on the first display region 210 in response to the received input event.

Then the display control module 170 may receive a notification signal for providing notification information and thus control the display 150 to display a notification UI (e.g., SNS event notification as shown) corresponding to the received notification signal on the first display region 210. Thereafter, if the display 150 receives a touch input event from the notification UI, the display control module 170 may control the display 150 to display a full screen (e.g., the SNS displayed on a full screen, as shown) of the notification UI on the first display region 210.

FIG. 13 is a flow diagram illustrating a process of displaying a user interface on a screen in accordance with various embodiments of the present disclosure.

Referring to FIG. 13, at operation 1301, the display control module 170 controls the display 150 to display at least two display regions thereon. Such display regions are divided by the separator, based on a screen division policy depending on a user's setting or predefined as a default. The display regions may be referred to as the first display region 210, the second display region 220, the third display region 230, and the like (as described earlier).

In an embodiment, when the display 150 or the input/output interface 140 detects an input event for executing a particular application, the display 150 displays the application on a selected one of the display regions at operation 1303.

In an embodiment, the display 150 detects a touch input event for triggering the user interface 500 at operation 1305. At this time, the touch input event may be detected through the display 150 or the input/output interface 140.

In an embodiment, at operation 1307, the display control module 170 controls the display 150 to display the user interface 500 on a specific display region determined according to a predefined policy. In this disclosure, the user interface 500 may include at least one of a menu UI used for invoking a selected function, a text input UI used for entering a text input, a keypad input UI used for entering a numeric input, a pop-up UI for offering information, and/or a notification UI for offering a notification, etc.

At operation 1307, the specific display region for displaying the user interface 500 may be determined as a display region that receives no input event. Alternatively, the display control module 170 may determine whether each display region is activated or inactivated, then assign the user interface 500 to an inactivated display region, and control the display 150 to display the user interface 500 on the inactivated display region.

In an embodiment, the specific display region for displaying the user interface 500 may be determined as a display region that fails to display the execution screen of an application. Alternatively, the display control module 170 may determine whether there is a display region in which a predetermined time has passed since the detection of the last input event. Based on the results of such determinations, the display control module 170 may select a specific display region and controls the display 150 to display the user interface 500 on the selected display region.

The display 150 may identify individual functions offered by the user interface 500, and then display the user interface 500 in the form of, for example, a list, in which several items linked to the identified functions are arranged. Additionally, the display 150 may further display the scroll bar 600 to scroll in the user interface 500.

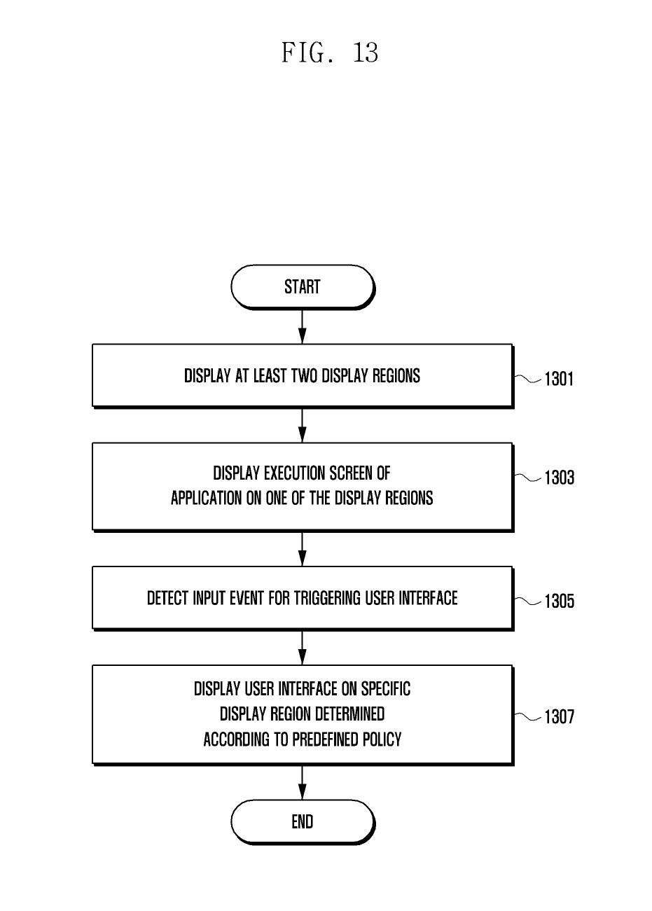

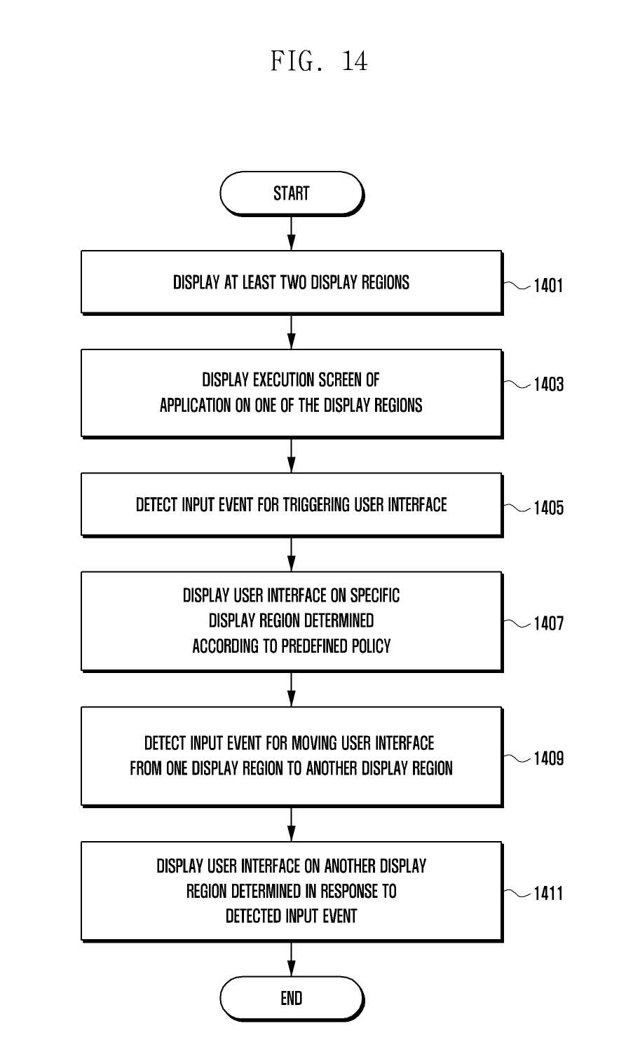

FIG. 14 is a flow diagram illustrating a process of moving a user interface on a screen in accordance with various embodiments of the present disclosure.

Referring to FIG. 14, at operation 1401, the display control module 170 controls the display 150 to display at least two display regions thereon. Such display regions are divided by the separator, based on a screen division policy depending on a user's setting or predefined as a default. The display regions may be referred to as the first display region 210, the second display region 220, the third display region 230, and the like.

When the display 150 or the input/output interface 140 detects an input event for executing a particular application, the display 150 displays the application on a selected one of the display regions at operation 1403.

The display 150 detects a touch input event for triggering the user interface 500 at operation 1405. At this time, the touch input event may be detected through the display 150 or the input/output interface 140.

At operation 1407, the display control module 170 controls the display 150 to display the user interface 500 on a specific display region determined according to a predefined policy. The user interface 500 may include at least one of a menu UI used for invoking a selected function, a text input UI used for entering a text input, a keypad input UI used for entering a numeric input, a pop-up UI for offering information, or a notification UI for offering a notification.

At this operation, the specific display region for displaying the user interface 500 may be determined as a display region that receives no input event. Alternatively, the display control module 170 may determine whether each display region is activated or inactivated, then assign the user interface 500 to an inactivated display region, and control the display 150 to display the user interface 500 on the inactivated display region.

In an embodiment, the specific display region for displaying the user interface 500 may be determined as a display region that fails to display the execution screen of an application. Alternatively, the display control module 170 may determine whether there is a display region in which a predetermined time has passed after the detection of the last input event. Based on the result of such determination, the display control module 170 selects a specific display region and controls the display 150 to display the user interface 500 on the selected display region.

The display 150 may identify individual functions offered by the user interface 500, and then display the user interface 500 in the form of a list in which several items linked to the identified functions are arranged. Additionally, the display 150 may further display the scroll bar 600 to facilitate scrolling within the user interface 500.

If the display 150 detects an input event for moving the user interface 500 from one display region to another display region at operation 1409, the display control module 170 may control at operation 1411 the display 150 to display the user interface 500 on the latter display region determined in response to the detected input event.

For example, a user may touch a certain spot on the user interface 500 and drag it toward a certain direction on the screen 200. Then, in response to this touch and drag input, the electronic device 101 may providing a suitable UI or GUI in which the user interface 500 leaves, moves or otherwise escapes from a current frame and moves in a direction of the touch and drag input. If the user interface 500 moves more than a given threshold range (e.g., beyond the separator 300), the user interface 500 may be transitioned to be displayed on the target display region.

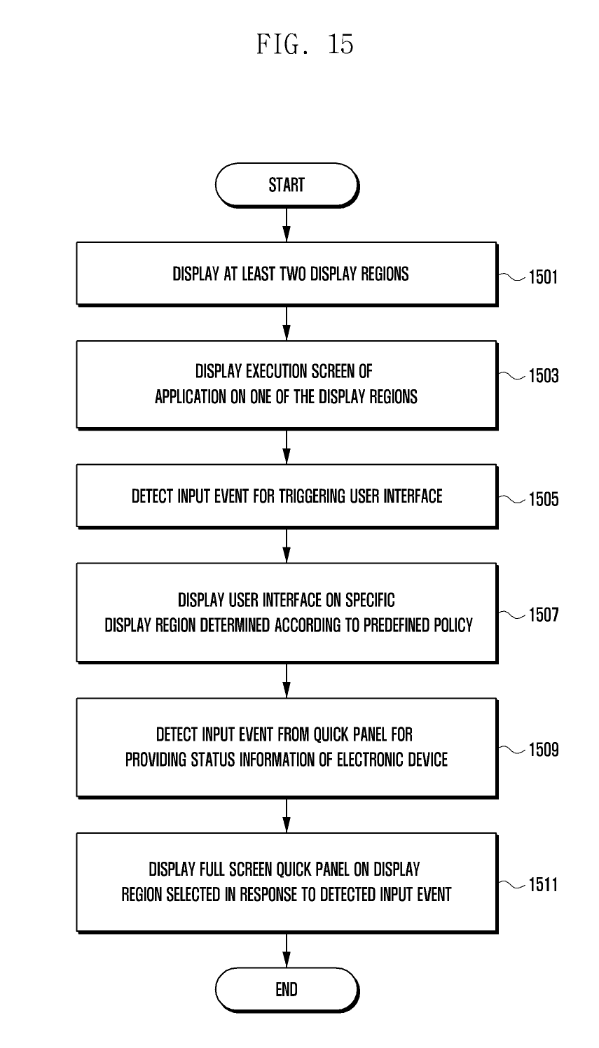

FIG. 15 is a flow diagram illustrating a process of displaying a quick panel on a screen in accordance with various embodiments of the present disclosure.

Referring to FIG. 15, at operation 1501, the display control module 170 controls the display 150 to display at least two display regions thereon. Such display regions are divided by the separator, based on a screen division policy depending on a user's setting or predefined as a default. The display regions may be referred to as the first display region 210, the second display region 220, the third display region 230, and the like.

In an embodiment, when the display 150 or the input/output interface 140 detects an input event for executing a particular application, the display 150 displays the application on a selected one of the display regions at operation 1503.

In an embodiment, the display 150 detects a touch input event for triggering the user interface 500 at operation 1505. At this time, the touch input event may be detected through the display 150 or the input/output interface 140.

In an embodiment, at operation 1507, the display control module 170 controls the display 150 to display the user interface 500 on a specific display region determined according to a predefined policy. The user interface 500 may include at least one of a menu UI used for invoking a selected function, a text input UI used for entering a text input, a keypad input UI used for entering a numeric input, a pop-up UI for offering information, or a notification UI for offering a notification.

At this operation, the specific display region for displaying the user interface 500 may be determined as a display region that receives no input event. Alternatively, the display control module 170 may determine whether each display region is activated or inactivated, then assign the user interface 500 to an inactivated display region, and control the display 150 to display the user interface 500 on the inactivated display region.

In an embodiment, the specific display region for displaying the user interface 500 may be determined as a display region that fails to display the execution screen of an application. Alternatively, the display control module 170 may determine whether there is a display region in which a predetermined time has passed after the detection of the last input event. Based on the result of such determination, the display control module 170 selects a specific display region and controls the display 150 to display the user interface 500 on the selected display region.

The display 150 may identify individual functions offered by the user interface 500, and then display the user interface 500 in the form of a list in which several items linked to the identified functions are arranged. Additionally, the display 150 may further display the scroll bar 600 to scroll in the user interface 500.

At operation 1509, the display 150 detects an input event from the quick panel 400. In this disclosure, the quick panel 400 may include a function to provide status information, notification information, etc. regarding the electronic device 101 and also to selectively display information in response to a predefined input event (e.g., a single touch input event or a drag and drop input event). Using the quick panel 400, a user can check quickly the current status or the like of the electronic device 101.

At operation 1511, the display 150 may display a full screen version of the quick panel 400 on a particular display region selected in response to the detected input event.

In one embodiment, the display 150 may detect a touch-based input event that occurs at the quick panel 400 and is then released (i.e., a drop input event) from one of the display regions, and then select the touch-released display region as a particular display region for displaying a full screen of the quick panel 400. Also, the display control module 170 may control the display 150 to display the full screen of the quick panel 400 on the selected display region.

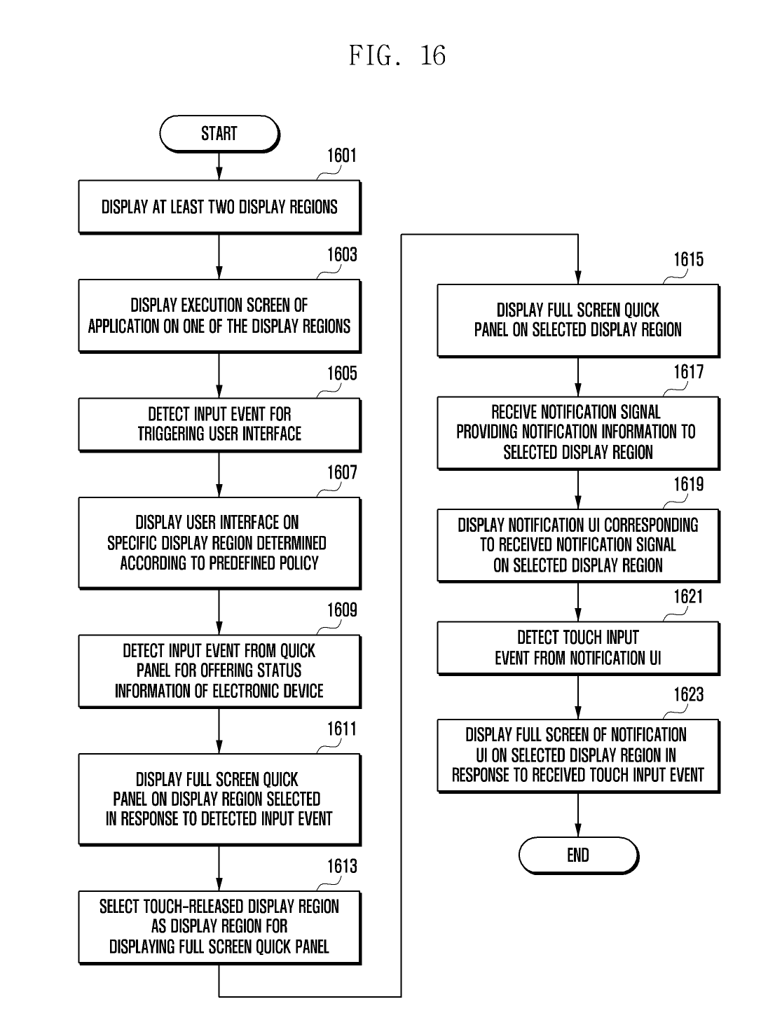

FIG. 16 is a flow diagram illustrating a process of displaying a notification UI on a screen in accordance with various embodiments of the present disclosure.

Referring to FIG. 16, at operation 1601, the display control module 170 controls the display 150 to display at least two display regions thereon. Such display regions may be divided by the separator, based on a screen division policy depending on a user's setting or predefined as a default. The display regions may be referred to as the first display region 210, the second display region 220, the third display region 230, and the like.

In an embodiment, when the display 150 or the input/output interface 140 detects an input event for executing a particular application, the display 150 displays the application on a selected one of the display regions at operation 1603.

In an embodiment, the display 150 detects a touch input event for triggering the user interface 500 at operation 1605. At this time, the touch input event may be detected through the display 150 or the input/output interface 140.

In one embodiment, at operation 1607, the display control module 170 controls the display 150 to display the user interface 500 on a specific display region determined according to a predefined policy. The user interface 500 may include at least one of a menu UI used for invoking a selected function, a text input UI used for entering a text input, a keypad input UI used for entering a numeric input, a pop-up UI for offering information, or a notification UI for offering a notification.

At this operation, the specific display region for displaying the user interface 500 may be determined as a display region that does not receive an input event. Alternatively, the display control module 170 may determine whether each display region is activated or inactivated, assign the user interface 500 to an inactivated display region, and control the display 150 to display the user interface 500 on the inactivated display region.

In one embodiment, the specific display region for displaying the user interface 500 may be determined as a display region that fails to display the execution screen of an application. Alternatively, the display control module 170 may determine whether there is a display region in which a predetermined time has passed after the detection of the last input event. Based on the result of such determination, the display control module 170 selects a specific display region and controls the display 150 to display the user interface 500 on the selected display region.

The display 150 may identify individual functions offered by the user interface 500, and then display the user interface 500 in the form of a list, on which several items linked to the identified functions are arranged. Additionally, the display 150 may further display the scroll bar 600 to facilitate scrolling within the user interface 500.

At operation 1609, the display 150 detects an input event from the quick panel 400. The quick panel 400 may provide status information, notification information, etc. regarding the electronic device 101 and also selectively display information in response to a predefined input event (e.g., a single touch input event or a drag and drop input event). Using the quick panel 400, a user may view the current status or the like of the electronic device 101.

At operation 1611, the display 150 may detect a touch-based input event that occurs at the quick panel 400, and is then released (e.g., a drop input event) from one of the display regions. Then, at operation 1613, the display control module 170 selects the touch-released display region as a particular display region for displaying a full screen of the quick panel 400. Also, at operation 1615, the display control module 170 controls the display 150 to display the full screen of the quick panel 400 on the selected display region. For example, if the display 150 detects a drop input event released from one of the first and second display regions 210 and 220, the display control module 170 determines the input-released display region to be used for displaying the full screen of the quick panel 400. Then the display 150 displays the full screen of the quick panel 400 on the determined display region.

Thereafter, at operation 1617, the display 150 may receive a notification signal that offers certain notification information to the selected display region. In this operation, the notification information may include information about SNS message, weather, calendar, photo update, stock, call, or any other notification stored in advance by a user.

At operation 1619, the display 150 displays a notification UI corresponding to the received notification signal on the selected display region. Also, at operation 1621, the display 150 receives a touch input event from the notification UI. Then, at operation 1623, the display control module 170 controls the display 150 to display a full screen of the notification UI on the selected display region in response to the received touch input event. This displaying operation may be a change from the full screen of the quick panel 400 to the full screen of the notification UI. Meanwhile, the notification UI displayed before the full screen is displayed may have a predetermined position and size on the selected display region, such as a position disposed at the center of the selected display region and a size corresponding to a tenth of the selected display region.

According to various embodiments, a method for a display control of the electronic device 101 may include an operation of displaying at least two display regions; an operation of displaying an execution screen of an application on one of the at least two display regions; operation of detecting an input event for displaying the user interface 500; and an operation of displaying the user interface 500 corresponding to the input event on a specific display region selected from among the at least two display regions according to a predefined policy.

In one embodiment, the operation of displaying the user interface 500 may include an operation of displaying the user interface 500 on a display region from which the input event is not detected.

In one embodiment, the operation of displaying the user interface 500 may include an operation of determining whether each of the at least two display regions is activated or inactivated, and operation of, based on the result of determination, displaying the user interface 500 on the inactivated display region.

In one embodiment, the operation of displaying the user interface 500 may include operation of detecting a selection input event for selecting a display region to be used for displaying the user interface 500; operation of selecting the display region in response to the selection input event; and operation of displaying the user interface 500 on the selected display region.

In one embodiment, the user interface 500 may include at least one of a menu UI (user interface) used for invoking a selected function, a text input UI used for entering a text input, a keypad input UI used for entering a numeric input, a pop-up UI for offering information, or a notification UI for offering a notification.

In one embodiment, the operation of displaying the user interface 500 may include at least one of operation of identifying individual functions offered by the user interface 500 and then displaying the user interface 500 in the form of a list in which several items linked to the identified functions are arranged; or an operation of displaying the scroll bar 600 to scroll in the user interface 500.

In one embodiment, the method may further include an operation of, after displaying the user interface 500, detecting a move input event for moving the user interface 500 from the selected display region to a new display region; and an operation of moving the user interface 500 to the new display region in response to the detected move input event.

In one embodiment, the operation of displaying the user interface 500 may include an operation of determining whether there is a display region that fails to display the execution screen of the application or there is a display region in which a predetermined time has passed after detection of the input event; an operation of, based on the result of determination, selecting the specific display region; and an operation of displaying the user interface 500 on the selected display region.

In one embodiment, the method may further include an operation of detecting an input event from the quick panel 400 that offers status information of the electronic device; and an operation of displaying a full screen of the quick panel 400 on a specific display region determined in response to the detected input event.

In one embodiment, the operation of displaying the full screen of the quick panel 400 may include an operation of detecting a touch-based input event that occurs at the quick panel 400 and is then released from one of the display regions; an operation of selecting the touch-released display region as a particular display region to be used for displaying the full screen of the quick panel 400; and an operation of displaying the full screen of the quick panel 400 on the selected display region.

In one embodiment, the operation of displaying the full screen of the quick panel 400 may further include, after displaying the full screen of the quick panel, an operation of receiving a notification signal that offers notification information; and operation of displaying a notification UI corresponding to the received notification signal on the selected display region.

In one embodiment, the operation of displaying the full screen of the quick panel 400 may further include, after displaying the notification UI, an operation of detecting a touch input event from the notification UI; and an operation of displaying a full screen of the notification UI on the selected display region in response to the detected touch input event.

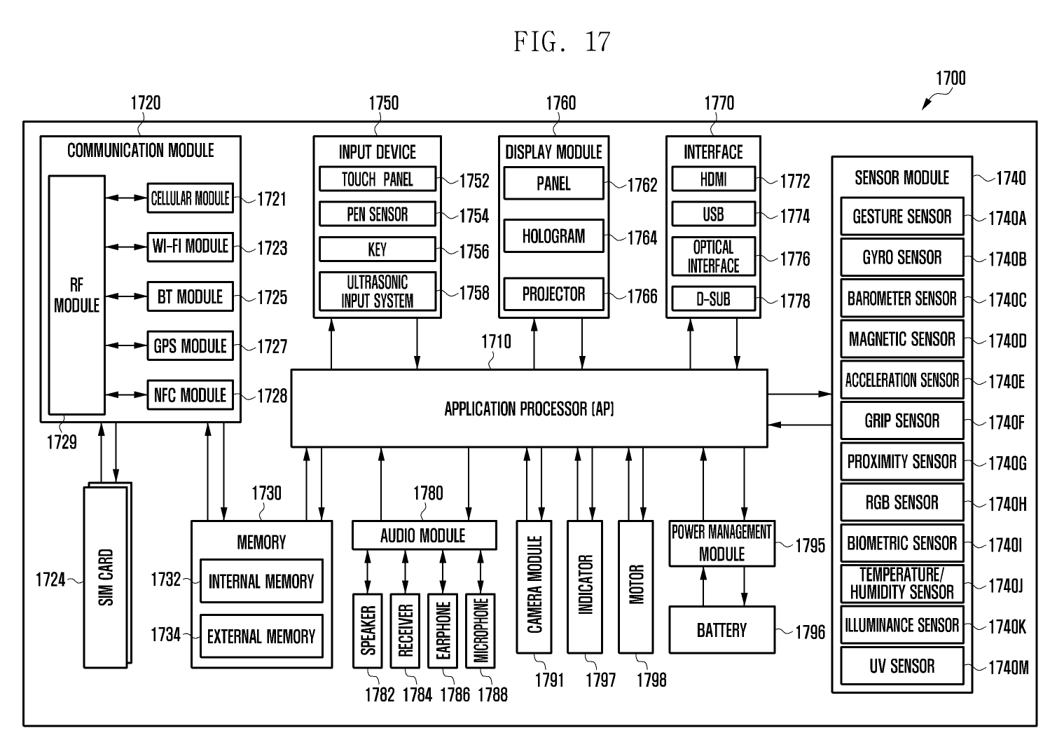

FIG. 17 is a block diagram of an electronic device 1700 according to various embodiments of the present disclosure.

The electronic device 1700 may configure, for example, a whole or a part of the electronic device 101 illustrated in FIG. 1. Referring to FIG. 17, the electronic device 1700 includes one or more Application Processors (APs) 1710, a communication module 1720, a Subscriber Identification Module (SIM) card 1724, a memory 1730, a sensor module 1740, an input device 1750, a display 1760, an interface 1770, an audio module 1780, a camera module 1791, a power managing module 1795, a battery 1796, an indicator 1797, and a motor 1798.

The AP 1710 operates an operating system (OS) or an application program so as to control a plurality of hardware or software component elements connected to the AP 1710 and execute various data processing and calculations including multimedia data. The AP 1710 may be implemented by, for example, a System on Chip (SoC). According to an embodiment, the processor 1710 may further include a Graphic Processing Unit (GPU). The processor 1710 may further include the display control module 170.

The communication module 1720 (for example, communication interface 160) transmits/receives data in communication between different electronic devices (for example, the electronic device 104 and the server 106) connected to the electronic device 1700 (for example, electronic device 101) through a network. According to an embodiment, the communication module 1720 includes a cellular module 1721, a WiFi module 1723, a BlueTooth (BT) module 1725, a Global Positioning System (GPS) module 1727, a Near Field Communication (NFC) module 1728, and a Radio Frequency (RF) module 1729.

The cellular module 1721 provides a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 1721 may distinguish and authenticate electronic devices within a communication network by using a subscriber identification module (for example, the SIM card 1724). According to an embodiment, the cellular module 1721 performs at least some of the functions which can be provided by the AP 1710. For example, the cellular module 1721 may perform at least some of the multimedia control functions.

According to an embodiment, the cellular module 1721 may include a Communication Processor (CP). Further, the cellular module 1721 may be implemented by, for example, an SoC. Although the components such as the cellular module 1721 (for example, communication processor), the memory 1730, and the power managing module 1795 are illustrated as components separate from the AP 1710 in FIG. 8, the AP 1710 may include at least some (for example, cellular module 1721) of the aforementioned components in an embodiment.

According to an embodiment, the AP 1710 or the cellular module 1721 (for example, communication processor) may load a command or data received from at least one of a non-volatile memory and other components connected to each of the AP 1710 and the cellular module 1721 to a volatile memory and process the loaded command or data. Further, the AP 1710 or the cellular module 1721 may store data received from at least one of other components or generated by at least one of other components in a non-volatile memory.

Each of the WiFi module 1723, the BT module 1725, the GPS module 1727, and the NFC module 1728 may include, for example, a processor for processing data transmitted/received through the corresponding module. Although the cellular module 1721, the WiFi module 1723, the BT module 1725, the GPS module 1727, and the NFC module 1728 are illustrated as blocks separate from each other in FIG. 8, at least some (for example, two or more) of the cellular module 1721, the WiFi module 1723, the BT module 1725, the GPS module 1727, and the NFC module 1728 may be included in one Integrated Chip (IC) or one IC package according to one embodiment. For example, at least some (for example, the communication processor corresponding to the cellular module 1721 and the WiFi processor corresponding to the WiFi module 1723) of the processors corresponding to the cellular module 1721, the WiFi module 1723, the BT module 1725, the GPS module 1727, and the NFC module 1728 may be implemented by one SoC.

The RF module 1729 transmits/receives data, for example, an RF signal. Although not illustrated, the RF module 1729 may include, for example, a transceiver, a Power Amp Module (PAM), a frequency filter, a Low Noise Amplifier (LNA) or the like. Further, the RF module 1729 may further include a component for transmitting/receiving electronic waves over a free air space in wireless communication, for example, a conductor, a conducting wire, or the like. Although the cellular module 1721, the WiFi module 1723, the BT module 1725, the GPS module 1727, and the NFC module 1728 share one RF module 1729 in FIG. 17, at least one of the cellular module 1721, the WiFi module 1723, the BT module 1725, the GPS module 1727, or the NFC module 1728 may transmit/receive an RF signal through a separate RF module according to one embodiment.

The SIM card 1724 is a card including a Subscriber Identification Module and may be inserted into a slot formed in a particular portion of the electronic device. The SIM card 1724 includes unique identification information (for example, Integrated Circuit Card IDentifier (ICCID)) or subscriber information (for example, International Mobile Subscriber Identity (IMSI).

The memory 1730 (for example, memory 130) may include an internal memory 1732 or an external memory 1734. The internal memory 1732 may include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable or programmable ROM (EEPROM), a mask ROM, a flash ROM, a NAND flash memory, an NOR flash memory, and the like).

According to an embodiment, the internal memory 232 may be a Solid State Drive (SSD). The external memory 1734 may further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 1734 may be functionally connected to the electronic device 1700 through various interfaces. According to an embodiment, the electronic device 1700 may further include a storage device (or storage medium) such as a hard drive.

The sensor module 1740 measures a physical quantity or detects an operation state of the electronic device 1700, and converts the measured or detected information to an electronic signal. The sensor module 1740 may include, for example, at least one of a gesture sensor 1740A, a gyro sensor 1740B, an atmospheric pressure (barometric) sensor 1740C, a magnetic sensor 1740D, an acceleration sensor 1740E, a grip sensor 1740F, a proximity sensor 1740G, a color sensor (for example, Red, Green, and Blue (RGB) sensor) 1740H, a biometric sensor 1740I, a temperature/humidity sensor 1740J, an illumination (light) sensor 1740K, or a Ultra Violet (UV) sensor 1740M. Additionally or alternatively, the sensor module 1740 may include, for example, a E-nose sensor, an electromyography (EMG) sensor, an electroencephalogram (EEG) sensor, an electrocardiogram (ECG) sensor, an InfraRed (IR) sensor, an iris sensor, a fingerprint sensor (not illustrated), and the like. The sensor module 1740 may further include a control circuit for controlling one or more sensors included in the sensor module 1740.

The input device 1750 includes a touch panel 1752, a (digital) pen sensor 1754, a key 1756, and an ultrasonic input device 1758. For example, the touch panel 1752 may recognize a touch input in at least one type of a capacitive type, a resistive type, an infrared type, and an acoustic wave type. The touch panel 1752 may further include a control circuit. In the capacitive type, the touch panel 1752 can recognize proximity as well as a direct touch. The touch panel 1752 may further include a tactile layer. In this event, the touch panel 1752 provides a tactile reaction to the user.

The (digital) pen sensor 1754 may be implemented, for example, using a method identical or similar to a method of receiving a touch input of the user, or using a separate recognition sheet. The key 1756 may include, for example, a physical button, an optical key, or a key pad. The ultrasonic input device 1758 is a device which can detect an acoustic wave by a microphone (for example, microphone 1788) of the electronic device 1700 through an input means generating an ultrasonic signal to identify data and can perform wireless recognition. According to an embodiment, the electronic device 1700 receives a user input from an external device (for example, computer or server) connected to the electronic device 1700 by using the communication module 1720.

The display 1760 (for example, display 150) includes a panel 1762, a hologram device 1764, and a projector 1766. The panel 1762 may be, for example, a Liquid Crystal Display (LCD) or an Active Matrix Organic Light Emitting Diode (AM-OLED). The panel 1762 may be implemented to be, for example, flexible, transparent, or wearable. The panel 1762 may be configured by the touch panel 1752 and one module. The hologram device 1764 shows a stereoscopic image in the air by using interference of light. The projector 1766 projects light on a screen to display an image. For example, the screen may be located inside or outside the electronic device 1700. According to an embodiment, the display 1760 may further include a control circuit for controlling the panel 1762, the hologram device 1764, and the projector 1766.

The interface 1770 includes, for example, a High-Definition Multimedia Interface (HDMI) 1772, a Universal Serial Bus (USB) 1774, an optical interface 1776, and a D-subminiature (D-sub) 1778. The interface 1770 may be included in, for example, the communication interface 160 illustrated in FIG. 1. Additionally or alternatively, the interface 1790 may include, for example, a Mobile High-definition Link (MHL) interface, a Secure Digital (SD) card/Multi-Media Card (MMC), or an Infrared Data Association (IrDA) standard interface.

The audio module 1780 bi-directionally converts a sound and an electronic signal. At least some components of the audio module 1780 may be included in, for example, the input/output interface 140 illustrated in FIG. 1. The audio module 1780 processes sound information input or output through, for example, a speaker 1782, a receiver 1784, an earphone 1786, the microphone 1788 or the like.

The camera module 1791 is a device which can photograph a still image and a video. According to an embodiment, the camera module 1791 may include one or more image sensors (for example, a front sensor or a back sensor), an Image Signal Processor (ISP) (not shown) or a flash (for example, an LED or xenon lamp).

The power managing module 1795 manages power of the electronic device 1700. Although not illustrated, the power managing module 1795 may include, for example, a Power Management Integrated Circuit (PMIC), a charger Integrated Circuit (IC), or a battery or fuel gauge.

The PMIC may be mounted to, for example, an integrated circuit or an SoC semiconductor. A charging method may be divided into wired and wireless methods. The charger IC charges a battery and prevent over voltage or over current from flowing from a charger. According to an embodiment, the charger IC includes a charger IC for at least one of the wired charging method or the wireless charging method. The wireless charging method may include, for example, a magnetic resonance method, a magnetic induction method and an electromagnetic wave method, and additional circuits for wireless charging, for example, circuits such as a coil loop, a resonant circuit, a rectifier or the like may be added.

The battery fuel gauge measures, for example, a remaining quantity of the battery 1796, or a voltage, a current, or a temperature during charging. The battery 1796 may store or generate electricity and supply power to the electronic device 1700 by using the stored or generated electricity. The battery 1796 may include a rechargeable battery or a solar battery.

The indicator 1797 shows particular statuses of the electronic device 1700 or a part (for example, AP 1710) of the electronic device 1700, for example, a booting status, a message status, a charging status and the like. The motor 1798 converts an electrical signal to a mechanical vibration. Although not illustrated, the electronic device 1700 may include a processing unit (for example, GPU) for supporting a module TV. The processing unit for supporting the mobile TV may process, for example, media data according to a standard of Digital Multimedia Broadcasting (DMB), Digital Video Broadcasting (DVB), media flow or the like.

Each of the components of the electronic device according to various embodiments of the present disclosure may be implemented by one or more components and the name of the corresponding component may vary depending on a type of the electronic device. The electronic device according to various embodiments of the present disclosure may include at least one of the above described components, a few of the components may be omitted, or additional components may be further included. Also, some of the components of the electronic device according to various embodiments of the present disclosure may be combined to form a single entity, and thus may equivalently execute functions of the corresponding components before being combined.

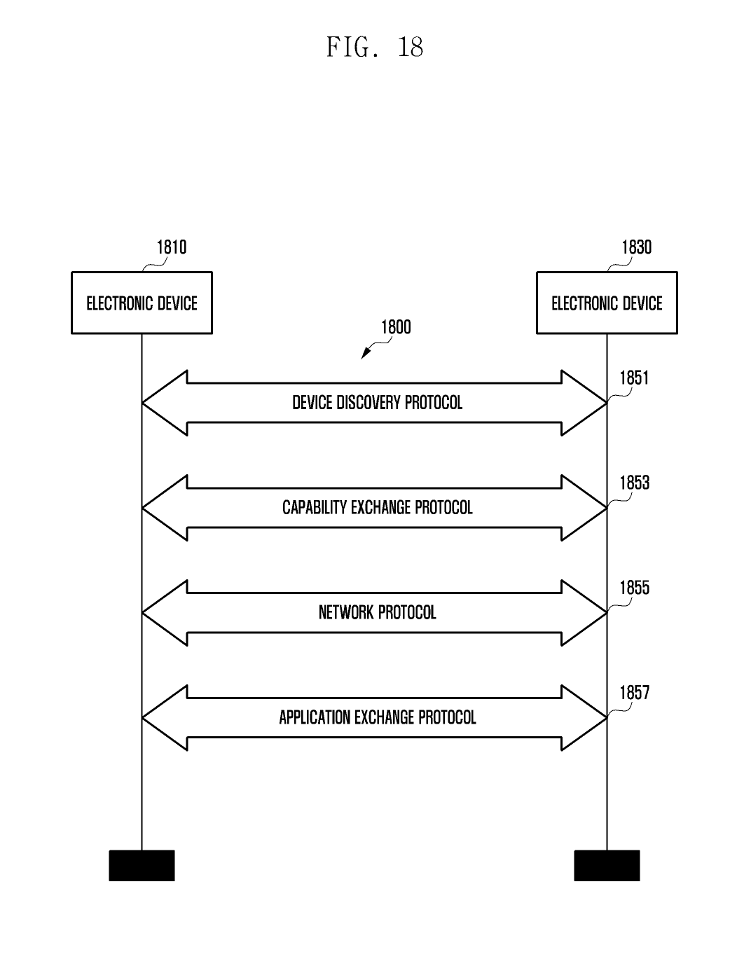

FIG. 18 illustrates communication protocols 1800 between a plurality of electronic devices (e.g., an electronic device 1810 and an electronic device 1830) according to various embodiments.

Referring to FIG. 18, for example, the communication protocols 1800 may include a device discovery protocol 1851, a capability exchange protocol 1853, a network protocol 1855, and an application protocol 1857.

According to an embodiment, the device discovery protocol 1851 may be a protocol by which the electronic devices (e.g., the electronic device 1810 and the electronic device 1830) detect external devices capable of communicating with the electronic devices, or connect with the detected external electronic devices. For example, the electronic device 1810 (e.g., the electronic device 101) may detect the electronic device 1830 (e.g., the electronic device 104) as an electronic device capable of communicating with the electronic device 1810 through communication methods (e.g., WiFi, BT, USB, or the like) which are available in the electronic device 1810, by using the device discovery protocol 1851. In order to connect with the electronic device 1830 for communication, the electronic device 1810 may obtain and store identification information on the detected electronic device 1830, by using the device discovery protocol 1851. The electronic device 1810 may initiate the communication connection with the electronic device 1830, for example, based on at least the identification information.

According to an embodiment, the device discovery protocol 1851 may be a protocol for authentication between a plurality of electronic devices. For example, the electronic device 1810 may perform authentication between the electronic device 1810 and the electronic device 1830, based on at least communication information {e.g., Media Access Control (MAC), Universally Unique Identifier (UUID), Subsystem Identification (SSID), Internet Protocol (IP) address} for connection with the electronic device 1830.

According to an embodiment, the capability exchange protocol 1853 may be a protocol for exchanging information related to service functions which can be supported by at least one of the electronic device 1810 or the electronic device 1830. For example, the electronic device 1810 and the electronic device 1830 may exchange information on service functions which are currently supported by each electronic device with each other through the capability exchange protocol 1853. The exchangeable information may include identification information indicating a specific service among a plurality of services supported by the electronic device 1810 and the electronic device 1830. For example, the electronic device 1810 may receive identification information for a specific service provided by the electronic device 1830 from the electronic device 1830 through the capability exchange protocol 1853. In this case, the first electronic device 1810 may determine whether the electronic device 1810 can support the specific service, based on the received identification information.

According to an embodiment, the network protocol 1855 may be a protocol for controlling the data flow which is transmitted and received between the electronic devices (e.g., the electronic device 1810 and the electronic device 1830) connected with each other for communication, for example, in order to provide interworking services. For example, at least one of the electronic device 1810 or the electronic device 1830 may perform the error control or the data quality control, by using the network protocol 1855. Alternatively or additionally, the network protocol 1855 may determine the transmission format of data transmitted and received between the electronic device 1810 and the electronic device 1830. In addition, at least one of the electronic device 1810 or the electronic device 1830 may manage a session (e.g., session connection or session termination) for the data exchange between them, by using the network protocol 1855.

According to an embodiment, the application protocol 1857 may be a protocol for providing a procedure or information to exchange data related to services which are provided to the external devices. For example, the electronic device 1810 (e.g., the electronic device 101) may provide services to the electronic device 1830 (e.g., the electronic device 104 or the server 106) through the application protocol 1857.

According to an embodiment, the communication protocol 1800 may include standard communication protocols, communication protocols designated by individuals or groups (e.g., communication protocols designated by communication device manufacturers or network providers), or a combination thereof.

The term “module” used in the present disclosure may refer to, for example, a unit including at least one combination of hardware, software, and firmware. The “module” may be interchangeably used with a term, such as unit, logic, logical block, component, and/or circuit. The “module” may be a minimum unit of an integrally configured article and/or a part thereof. The “module” may be a minimum unit performing at least one function and/or a part thereof. The “module” may be mechanically and/or electronically implemented. For example, the “module” according to the present disclosure may include at least one of an Application-Specific ICt (ASIC) chip, a Field-Programmable Gate Arrays (FPGA), or a programmable-logic device for performing operations which has been known and/or are to be developed hereinafter.

According to various embodiments, at least some of the devices (for example, modules or functions thereof) or the method (for example, operations) according to the present disclosure may be implemented by a command stored in a computer-readable storage medium in a programming module form. When the instructions are executed by at least one processor (e.g., the processor 1710), the at least one processor may perform functions corresponding to the instructions. The computer-readable storage medium may be, for example, the memory 1730. At least a part of the programming module may be implemented (for example, executed) by, for example, the processor 1710. At least some of the programming modules may include, for example, a module, a program, a routine, a set of instructions or a process for performing one or more functions.

The computer-readable recording medium may include magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

According to various embodiments of the present disclosure, in a computer-readable storage medium which records thereon various commands, the commands are defined to enable at least one processor to perform at least one operation when being executed by the processor. The operation may include displaying at least two display regions; displaying an execution screen of an application on one of the at least two display regions; detecting an input event for displaying a user interface; and displaying the user interface corresponding to the input event on a specific display region selected from among the at least two display regions according to a predefined policy.

According to an embodiment of this disclosure, it is possible to display a plurality of various applications on a single screen in a simple manner. This may offer a user-friendly, efficient and intuitive interface to a user.

According to an embodiment of this disclosure, a user can simply dispose and check a plurality of application through a plurality of individual display regions on the screen.

According to an embodiment of this disclosure, each individual display region assigned for displaying each individual application may be freely changed to a desired layout. This not only allows the effective configuration of screen, but also obviates the burden of manipulating multiple applications.

According to an embodiment of this disclosure, a user can simultaneously and effectively perform several tasks associated with applications in an environment of multiple display regions even on a small-sized screen of the electronic device. For example, while watching a video on the screen, a user can perform any other task such as writing a new message or email.

According to an embodiment of this disclosure, a user can select display regions with regard to multiple applications, thus efficiently displaying applications and utilizing functions thereof. Additionally, a display region for displaying a user interface may be determined on the basis of activation priorities or the like of display regions, and this may offer convenience in use of screen to a user.

In conclusion, various embodiments disclosed herein may realize optimal screen environments of electronic devices, thereby enhancing user convenience and improving usability, accessibility and competitiveness of electronic devices.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

The example embodiments disclosed in the specification and drawings are merely presented to easily describe technical contents of the present disclosure and help the understanding of the present disclosure and are not intended to limit the present disclosure. Therefore, all changes or modifications derived from the technical idea of the present disclosure as well as the embodiments described herein should be interpreted to belong to the present disclosure.

What is claimed is:

1. A method in an electronic device, comprising:
displaying at least two display regions on a display of the electronic device;
displaying an execution screen of an application on one of the at least two display regions; and
in response to detecting an input event for displaying a user interface, displaying the user interface on one of the at least two display regions according to a predefined policy.

2. The method of claim 1, wherein displaying the user interface further comprises displaying the user interface on one of the at least two display regions on which the input event is not detected.

3. The method of claim 1, wherein displaying the user interface further comprises:
determining which of the at least two display regions is inactivated and displaying the user interface on one of the at least two display regions that is inactivated.

4. The method of claim 1, wherein displaying the user interface further comprises:
detecting a selection input event selecting one of the at least two display regions for displaying the user interface, and displaying the user interface on the selected one of the at least two display regions.

5. The method of claim 1, wherein the user interface includes at least one of a menu UI (user interface) selectable to invoke a selected function, a text input UI selectable to enter a text input, a keypad input UI selectable to enter a numeric input, a pop-up UI for providing information, and a notification UI for providing a notification.

6. The method of claim 1, wherein displaying the user interface further comprises at least one of:
identifying individual functions provided by the user interface and displaying the user interface as a list including an arrangement of items, each of the items selectable to executed at least one of the identified individual functions; and
displaying a scroll bar selectable to scroll the user interface.

7. The method of claim 1, further comprising:
detecting a move input event dragging the displayed user interface to a new display region of the at least two display regions, and moving the user interface to the new display region in response to the detected move input event.

8. The method of claim 1, wherein displaying the user interface further comprises:
determining whether one of the at least two display regions comprises an inactive display region that does not display the execution screen of the application, or does not receive any input event for a predetermined time; and
based on the result of determination, displaying the user interface on the inactive display region.

9. The method of claim 1, further comprising:
displaying a quick panel providing status information of the electronic device outside of the at least two display regions, and detecting an input event to the quick panel; and
in response to detecting the input event to the quick panel, displaying the quick panel on an entirety of one of the at least two display regions.

10. The method of claim 9, wherein the input event to the quick panel comprises a touch-based input event that is initially detected within the quick panel, moves to one of the at least two display regions, and is released within the one of the at least two display regions.

11. The method of claim 10, wherein displaying the quick panel on the entirety further includes:
receiving a notification signal that provides notification information, and displaying a notification UI corresponding to the received notification signal on the entirety of the one of the at least two display regions.

12. The method of claim 11, wherein the displaying the quick panel on the entirety further includes:
in response to detecting a touch input event on the displayed notification UI displaying the notification UI on the entirety of the one of the at least two display regions.

13. An electronic device, comprising:
a display unit; and
a processor configured to:
control the display unit to display at least two display regions,
control the display unit to display an execution screen of an application on one of the at least two display regions, and
in response to detecting an input event for displaying a user interface, control the display unit to display the user interface on one of the at least two display regions according to a predefined policy.

14. The electronic device of claim 13, wherein controlling the display unit to display the user interface further comprises displaying the user interface on one of the at least two display regions on which the input event is not detected.

15. The electronic device of claim 13, wherein controlling the display unit to display the user interface further comprises determining which of the at least two display regions is inactivated and displaying the user interface on one of the at least two display regions that is inactivated.

16. The electronic device of claim 13, wherein controlling the display unit to display the user interface further comprises detecting a selection input event selecting one of the at least two display regions for displaying the user interface, and controlling the display unit to display the user interface on the selected one of the at least two display regions.

17. The electronic device of claim 13, wherein the user interface includes at least one of a menu UI (user interface) selectable to invoke a selected function, a text input UI selectable to enter a text input, a keypad input UI selectable to enter a numeric input, a pop-up UI for providing information, and a notification UI for providing a notification.

18. The electronic device of claim 13, wherein controlling the display unit to display the user interface further comprises:
identifying individual functions provided by the user interface and displaying the user interface as a list including an arrangement of items, each of the items selectable to executed at least one of the identified individual functions; and
controlling the display unit to display a scroll bar selectable to scroll the user interface.

19. The electronic device of claim 13, wherein the processor is further configured to detect a move input event dragging the displayed user interface to a new display region of the at least two display regions, and move the user interface to the new display region in response to the detected move input event.

20. The electronic device of claim 13, wherein the processor is further configured to:
determine whether one of the at least two display regions comprises an inactive display region that does not display the execution screen of the application, or does not receive any input event for a predetermined time, and based on the result of determination, control the display unit to display the user interface on the inactive display region.

21. The electronic device of claim 13, wherein the processor is further configured to: control the display unit to display a quick panel providing status information of the electronic device outside of the at least two display regions, and detecting an input event to the quick panel; and
in response to detecting the input event to the quick panel, controlling the display unit to display the quick panel on an entirety of one of the at least two display regions.

22. The electronic device of claim 21, wherein the input event to the quick panel comprises a touch-based input event that is initially detected within the quick panel, moves to one of the at least two display regions, and is released within the one of the at least two display regions.

23. The electronic device of claim 22, wherein controlling the display unit to display the quick panel on the entirety further includes receiving a notification signal that provides notification information, and displaying a notification UI corresponding to the received notification signal on the entirety of the one of the at least two display regions.

24. The electronic device of claim 23, wherein the displaying the quick panel on the entirety further includes:
in response to detecting a touch input event on the displayed notification UI, controlling the display unit to display the notification UI on the entirety of the one of the at least two display regions.

25. A non-transitory computer-readable storage medium recording thereon a program executable by a processor for performing operations of:
displaying at least two display regions on a display of the electronic device;
displaying an execution screen of an application on one of the at least two display regions; and
in response to detecting an input event for displaying a user interface, displaying the user interface on one of the at least two display regions according to a predefined policy.
